(19) United States
(12) Patent Application Publication
(10) Pub. No.: US 2014/0349109 A1
(43) Pub. Date: Nov. 27, 2014

(54) PRESSURE SENSITIVE ADHESIVES BASED ON CARBOXYLIC ACIDS AND EPOXIDES

(71) Applicants: State of Oregon acting by and through the State Board of Higher Education on behalf of Oregon, (unknown); State University, Corvallis, OR (US)

(72) Inventors: Kaichang Li, Corvallis, OR (US); Anlong Li, Corvallis, OR (US)

(73) Assignees: State of Oregon acting by and through the State Board of Higher Education of behalf of Oregon; State University, Corvallis, OR (US)

(21) Appl. No.: 14/363,780

(22) PCT Filed: Dec. 5, 2012
(86) PCT No.: PCT/US2012/067961

§ 371 Date: Jun. 6, 2014

Related U.S. Application Data
(60) Provisional application No. 61/568,103, filed on Dec. 7, 2011.

(51) Int. Cl. C09J 163/00; C09J 7/02; B32B 37/26; C09J 163/08

(52) U.S. Cl. CPC C09J 163/00; C09J 163/08; C09J 7/0207; B32B 37/26; C09J 2463/008; B32B 2037/268
USPC 428/355 EP; 528/295.3; 525/533; 528/296; 427/208.4; 156/330

(57) ABSTRACT

A method for making a pressure sensitive adhesive comprising:
(a) reacting (i) at least one dibasic acid or anhydride thereof with (ii) at least one epoxide having at least two epoxy groups, one diol or polyol, or one diamine at a stoichiometric molar excess of reactive carboxylic acid groups relative reactive epoxy groups, hydroxyl groups or amine groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group; and
(b) curing the resulting carboxylic acid-capped prepolymer or oligomer with at least one polyfunctional epoxy to produce a pressure sensitive adhesive, wherein the polyfunctional epoxy is not an epoxidized vegetable oil.

A method for making a pressure sensitive adhesive comprising:
(a) reacting at least one dibasic acid or anhydride thereof with at least one epoxide having at least two epoxy or oxirane groups at a stoichiometric molar excess of reactive epoxy or oxirane groups relative reactive carboxylic acid groups to produce a thermoplastic prepolymer or oligomer capped with an epoxy or an oxirane group at both prepolymer or oligomer chain ends, or a thermoplastic branched prepolymer or oligomer with at least two of the prepolymer or oligomer branches and chain ends capped with an epoxy or oxirane group; and
(b) (i) curing the resulting epoxy-capped prepolymer or oligomer with at least one polybasic acid, or (ii) thermally curing the resulting epoxy-capped prepolymer or oligomer, to produce a pressure sensitive adhesive.

### CROSS REFERENCE TO RELATED APPLICATION

This application claims priority to U.S. Provisional Application No. 61/568,103 filed Dec. 7, 2011, which is incorporated herein in its entirety.

### BACKGROUND

Pressure sensitive adhesive (PSA) (also known as “self-adhesive” or “self-stick adhesive”) is adhesive which forms a bond at room temperature with a variety of dissimilar surfaces when light pressure is applied. No solvent, heat or radiation is needed to activate the adhesive. It finds wide applications in pressure-sensitive tapes, general purpose labels, post-it notes, postage stamps, and a wide variety of other products, e.g., packaging, automobile trim assembly, sound/vibration damping films, maternity and child care products like diapers, and hospital and first aid products like wound care dressings. Nowadays, most commercially available PSAs are derived from acrylic, modified acrylic, rubber and silicone-based formulations. The present invention for the first time provides the preparation of new PSA compositions based on epoxy resins and PSA products thereof.

Over the last several decades, application of epoxy resins has been primarily centered on thermosetting materials in industry, which were built on the lability of the oxirane or epoxy functionality to nucleophilic attack by amines, carboxylates and other species. Such epoxy thermosetting resins can be commonly found in powder coatings, solvent-free and solvent-borne coatings, composites for electrical laminates and two-part adhesives, etc. Despite the spectacular success of epoxy-based materials in the thermoset arena, thermoplastic epoxy polymers have received comparatively little attention. Only a few studies were documented on the stoichiometrically-balanced polymerizations of diglycidyl ethers with difunctional amines, bisphenols, difunctional sulfonamides, dicarboxylic acids or dithiols, yielding a family of thermoplastic resins (see, e.g., “Epoxy-based Thermoplastics: New Polymers With Unusual Property Profiles” by J. E. White, et al. (chapter 10 of the book Specialty Monomers and Polymers: Synthesis, Properties, and Applications, 2000), “Polyhydroxyethers. I. Effect of Structure on Properties of High Molecular Weight Polymers from Dihydric Phenols and Epichlorohydrin” by N. H. Reinking, et al. (J. Appl. Poylm. Sci. 1963)).

### SUMMARY

Disclosed herein are pressure sensitive adhesive (PSA) compositions, PSA constructs, methods for making PSA compositions and methods for making PSA constructs.

One embodiment is a method for making a pressure sensitive adhesive comprising:

(a) reacting at least one dibasic acid or anhydride thereof with at least one polyfunctional epoxide to produce a thermoplastic epoxy prepolymer or oligomer, wherein the polyfunctional epoxide is not an epoxidized vegetable oil; and

(b) thermally curing the resulting thermoplastic epoxy prepolymer or oligomer to produce a pressure sensitive adhesive. The thermal curing may be at a temperature from 20 to 350° C., preferably from 60 to 220° C., and more particularly from 80 to 180° C.

A further embodiment is a method for making a pressure sensitive adhesive comprising:

(a) reacting at least one dibasic acid or anhydride thereof with at least one epoxide having at least two epoxy groups, at least one diol or polyol, or at least one diamine at a stoichiometric molar excess of reactive carboxylic acid groups relative to reactive epoxy groups, hydroxyl groups or amine groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group; and

(b) thermally curing the resulting carboxylic acid-capped prepolymer or oligomer with at least one polyfunctional epoxide to produce a pressure sensitive adhesive, wherein the polyfunctional epoxide is not an epoxidized vegetable oil.

An additional embodiment is a method for making a pressure sensitive adhesive comprising:

(a) reacting at least one dibasic acid or anhydride thereof with at least one epoxide having at least two epoxy or oxirane groups at a stoichiometric molar excess of reactive epoxy or oxirane groups relative to reactive carboxylic acid groups to produce a thermoplastic prepolymer or oligomer capped with an epoxy or an oxirane group at both prepolymer or oligomer chain ends, or a thermoplastic branched prepolymer or oligomer with at least two of the prepolymer or oligomer branches and chain ends capped with an epoxy or oxirane group; and

(b) (i) curing the resulting epoxy-capped prepolymer or oligomer with at least one polybasic acid, or (ii) thermally curing the resulting epoxy-capped prepolymer or oligomer, to produce a pressure sensitive adhesive.

Pressure sensitive adhesives made by the method described herein are also disclosed.

Also disclosed herein is a pressure sensitive adhesive construct comprising:

(A) a backing substrate; and

(B) a pressure sensitive adhesive composition disposed on the backing substrate, wherein the pressure sensitive adhesive composition includes a pressure sensitive adhesive made by any of the methods described herein.

Further disclosed herein is a method for making a pressure sensitive adhesive construct comprising:

reacting at least one dibasic acid or anhydride thereof with at least one polyfunctional epoxide to produce a thermoplastic epoxy prepolymer or oligomer, wherein the polyfunctional epoxide is not an epoxidized vegetable oil; and

forming on a backing substrate a pressure sensitive adhesive from the resulting reaction product.

Additionally disclosed herein is a method for making a pressure sensitive adhesive construct comprising:

reacting at least one dibasic acid or anhydride thereof with at least one epoxide having at least two epoxy groups, at least one diol or polyol, or at least one diamine at a stoichiometric molar excess of reactive carboxylic acid groups relative to reactive epoxy groups, hydroxyl groups or amine groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group;

reacting the carboxylic acid-capped prepolymer or oligomer with at least one polyfunctional epoxide; and

forming on a backing substrate a pressure sensitive adhesive from the resulting reaction product.

Further disclosed herein is a method for making a pressure sensitive adhesive construct comprising:

reacting at least one dibasic acid or anhydride thereof with at least one epoxide having at least two epoxy or oxirane groups at a stoichiometric molar excess of reactive epoxy or oxirane groups relative to reactive carboxylic acid groups to produce a thermoplastic prepolymer or oligomer capped with an epoxy or oxirane group at both prepolymer or oligomer chain ends, or a thermoplastic branched prepolymer or oligomer with at least two of the prepolymer or oligomer branches and chain ends capped with an epoxy or oxirane group; and

forming on a backing substrate a pressure sensitive adhesive from the resulting reaction product.

Also disclosed herein is a method for making a pressure sensitive adhesive construct comprising:

reacting at least one dibasic acid or anhydride thereof with at least one epoxide having at least two epoxy or oxirane groups at a stoichiometric molar excess of reactive epoxy or oxirane groups relative to reactive carboxylic acid groups to produce a thermoplastic prepolymer or oligomer capped with an epoxy or oxirane group at both prepolymer or oligomer chain ends, or a thermoplastic branched prepolymer or oligomer with at least two of the prepolymer or oligomer branches and chain ends capped with an epoxy or oxirane group;

reacting the epoxy-capped prepolymer or oligomer with at least one polybasic acid; and

forming on a backing substrate a pressure sensitive adhesive from the resulting reaction product.

Also disclosed herein is a method comprising applying the pressure sensitive adhesive disclosed herein to a first substrate and then adhesively bonding the pressure sensitive adhesive-applied first substrate to a second substrate.

The foregoing will become more apparent from the following detailed description, which proceeds with reference to the accompanying figures.

### BRIEF DESCRIPTION OF THE DRAWINGS

FIG. 1 illustrates a combination of reactive extrusion and reactive calendar for the preparation of PSA and PSA constructs as disclosed herein.

### DETAILED DESCRIPTION

As used herein, the singular terms “a,” “an,” and “the” include plural referents unless context clearly indicates otherwise. Also, as used herein, the term “comprises” means “includes.”

The term “aliphatic” is defined as including alkyl, alkenyl, alkynyl, halogenated alkyl and cycloalkyl groups as described above. A “lower aliphatic” group is a branched or unbranched aliphatic group having from 1 to 10 carbon atoms.

The term “alkyl” refers to a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, decyl, tetradecyl, hexadecyl, eicosyl, tetracosyl and the like. A “lower alkyl” group is a saturated branched or unbranched hydrocarbon having from 1 to 10 carbon atoms. Preferred alkyl groups have 1 to 4 carbon atoms. Alkyl groups may be “substituted alkyls” wherein one or more hydrogen atoms are substituted with a substituent such as halogen, cycloalkyl, alkoxy, amino, hydroxyl, aryl, or carboxyl.

The term “aryl” refers to any carbon-based aromatic group including, but not limited to, phenyl, naphthyl, etc. The term “aryl” also includes “heteroaryl group,” which is defined as an aromatic group that has at least one heteroatom incorporated within the ring of the aromatic group. Examples of heteroatoms include, but are not limited to, nitrogen, oxygen, sulfur, and phosphorous. The aryl group can be substituted with one or more groups including, but not limited to, alkyl, alkynyl, alkenyl, aryl, halide, nitro, amino, ester, ketone, aldehyde, hydroxy, carboxylic acid, or alkoxy, or the aryl group can be unsubstituted.

The term “cycloalkyl” refers to a non-aromatic carbon-based ring composed of at least three carbon atoms. Examples of cycloalkyl groups include, but are not limited to, cyclopropyl, cyclobutyl, cyclopentyl, cyclohexyl, and the like. The term “heterocycloalkyl group” is a cycloalkyl group as defined above where at least one of the carbon atoms of the ring is substituted with a heteroatom such as, but not limited to, nitrogen, oxygen, sulfur, or phosphorous.

“Heteroalkyl” means an alkyl group wherein at least one carbon atom of the otherwise alkyl backbone is replaced with a heteroatom, for example, O, S or N.

Prepolymers, as described herein, may be reaction product mixtures after pre-polymerization but prior to (further) polymerization and curing reaction. The reaction product mixtures can consist of polymers of a wide spectrum of molecular weights. Oligomers have a low degree of polymerization (relatively low molecular weight). Prepolymer mixtures can include or consist of oligomers.

Disclosed herein are new PSA compositions based on carboxylic acids and epoxides, and methods for preparing PSA formulations, PSA tapes or other PSA products. In particular, the polymerization and/or curing reactions are based on the reaction of epoxy groups and carboxylic acid groups or anhydrides thereof. For example, illustrative repeating units for the polymers from the polymerization and/or curing reaction based on the reaction between an epoxy group and a carboxylic acid or anhydride group thereof can be represented as follows:

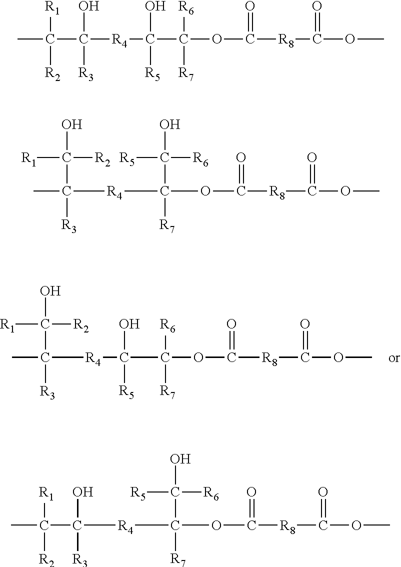

wherein each of R₁, R₂, R₃, R₄, R₅, R₆, R₇, and R₈ independently represents hydrogen or a substituted or unsubstituted alkyl or heteroalkyl group.

The PSA compositions generally possess low glass transition temperatures, sufficient cohesive strength, and good initial tack and adhesive powder. In addition, they are odorless and made without using organic solvents; and in some cases originate from only renewable raw materials. The chemical structure of the present compositions is particularly designed to meet the criteria for application as PSAs. The compositions generally possess glass transition temperatures below or at room temperature and have appropriate density of physical or chemical crosslinks, which render the compositions a balance between sufficient cohesive strength (“dry”) and good initial tack and adhesive power. For example, the T_{g} of the PSA compositions disclosed herein may be from −100 to 50° C., preferably from −80 to 40° C., more preferably from −50 to 30° C. It should be noted that, T_{g} of the PSAs should be fine-tuned to meet various demands of final PSA products. For example, preferred PSA for use in low peel labels will have a T_{g} of from −50 to −30° C. Preferred PSAs for use in freezer labels will have a T_{g} of from −45 to −30° C. Preferred PSAs for use in cold temperature labels will have a T_{g} of from −25 to −10° C. Preferred PSAs for use in PSA tapes will have a T_{g} of from −10 to 10° C. Preferred PSAs for use in high peel labels will have a T_{g} of from 0 to 10° C. Preferred PSAs for use in disposables will have a T_{g} of from 10 to 30° C. Furthermore, certain embodiments of the methods for making our PSA compositions and PSA products are characterized by a process which includes pre-polymerization and curing stages. Certain embodiments are characterized by a “thin-layer reactor” technology which facilitates making PSA products. Certain embodiments are characterized by a process that does not require any additional reactants or reactions (e.g., hardener) beyond the initial carboxylic acid-containing reactant(s) and the initial epoxy-containing reactant(s). In other words, the PSAs produced by the processes described herein are final products and further reactions of their components are not desirable.

Various thermoplastic epoxy polymers or oligomers capped with carboxylic acid groups or epoxy functionality at both chain ends were synthesized via non-stoichiometrically-balanced polymerizations of difunctional or polyfunctional epoxides with difunctional nucleophiles particularly aliphatic dibasic acids or their anhydride derivatives, followed by curing the thermoplastic epoxy resins to produce PSA compositions and PSA products. “Non-stoichiometrically-balanced” means at a stoichiometric molar excess of reactive carboxylic acid groups (or epoxy groups) relative to reactive epoxy groups (or carboxylic acid groups).

The epoxy resins can have many applications such as adhesives and coatings, but all known applications require further reaction(s) of the epoxy functional groups to enable the adhesive or coating properties. In contrast, PSAs typically are final products and further reactions of their components are not desirable. The preparation of PSAs from a simple one-step reaction between epoxy compounds/resins and dibasic acids is a novel approach for providing PSAs.

By careful selection of the monomer pairs, design of the monomer feed ratio, and optimization of the reaction conditions and operations, a rich array of polymer structure and physical properties can be obtained from various carboxylic acids and epoxides, thus making it possible to fine-tune the structure and related properties of them to meet the criteria for PSAs and various demands of final PSA products.

In certain embodiments, raw materials used in the disclosed methods and compositions are preferably derived from natural resources, e.g., vegetable oils and citric acid. Vegetable oils are one of the most abundant renewable raw materials, mainly a mixture of triglycerides with varying composition of long-chain saturated and unsaturated fatty acids depending on the plant, the crop, and the growing conditions. Fatty acids from vegetable oils can be easily dimerized or polymerized to produce dimer acid, trimer acid, and polymerized fatty acids, which can be used as dibasic acids or curing agents in presently disclosed methods. Furthermore, epoxides like dimer acid diglycidyl ester can also be easily derived from renewable dimer acids. The important fact that the epoxides, dibasic acids, and in some embodiments polyfunctional epoxides and polybasic acids, can all be obtained or derived from naturally abundant and renewable resources makes the presently disclosed compositions totally renewable PSAs.

In some embodiments, pre-polymerization of dibasic acids or anhydrides thereof with polyfunctional epoxides produces thermoplastic epoxy prepolymers or oligomers of an appropriate viscosity. In one embodiment, the pre-polymerization produces a thermoplastic epoxy prepolymer(s). In another embodiment, the pre-polymerization produces a thermoplastic epoxy oligomer(s). The thermoplastic epoxy prepolymers or oligomers are then cured at elevated temperatures (i.e., above ambient room temperature) to produce PSAs and PSA products such as tapes and labels. For example, one embodiment disclosed herein is a method for making a PSA comprising: (a) pre-polymerizing at least one dibasic acid with at least one polyfunctional epoxide to produce a thermoplastic epoxy prepolymer or oligomer, wherein the polyfunctional epoxide is not an epoxidized vegetable oil; and (b) thermally curing the resulting thermoplastic epoxy prepolymer or oligomer to produce a PSA. The curing reaction are carried out at a temperature suitably in the range from 20 to 350° C., preferably from 60 to 220° C., and more particularly from 80 to 180° C. The thermoplastic epoxy prepolymer or oligomer produced in step (a) may have a molecular weight (number average molecular weight) of no higher than 100,000, preferably no higher than 60,000, more particularly no higher than 30,000. A further embodiment disclosed herein is a PSA construct comprising: (a) a backing substrate; and (b) a PSA composition disposed on the backing substrate, wherein the PSA composition includes at least one thermoplastic epoxy polymer which is a polymerization product of at least one dibasic acid or anhydride thereof with at least one polyfunctional epoxide, wherein the polyfunctional epoxide is not an epoxidized vegetable oil.

In some embodiments, pre-polymerization of dibasic acids or anhydride derivatives thereof with polyfunctional epoxides can be carried out at a temperature suitably in the range from 20 to 300° C. for 1 to 180 minutes, preferably from 60 to 220° C. for 2 to 120 minutes, and more particularly from 80 to 180° C. for 5 to 60 minutes, to a degree that cross-linking does not obviously occur, and the viscosity of the intermediate reaction mixture is appropriate for blade-coating. If desired, the reaction is preferably carried out under an inert atmosphere free from oxygen, e.g., under nitrogen, since the mixtures are easily oxidized at high temperature to give dark-colored products.

The compositions may have an open time of up to about 5 or 240 minutes, depending on the nature and amount of the polyfunctional epoxides, the ratio of epoxy to carboxylic acid group, the viscosity of the reaction mixture, reaction temperature, and the nature and amount of catalysts used, etc. As used herein, “open time” denotes the time from mixing of dibasic acids with polyfunctional epoxides to the time at which cross-linking takes place and viscosity greatly increases to a point that the mixed composition can no longer be applied. Generally, the higher the reaction temperature, the shorter the open time. At lower temperature, the carboxylic acid or anhydride groups are mainly consumed by epoxy groups. At higher temperature, however, both epoxy groups and hydroxyl groups derived from carboxyl-epoxy reaction may react with carboxylic acid or anhydride groups. As the reaction proceeds further, the carboxylic acid-hydroxyl esterification reaction may dominate the reaction, with the result that the density of cross-linking increases and the mixed composition becomes more difficult for coating and less appropriate for PSAs.

Dibasic acids or their anhydride derivatives can be used in molar ratios of carboxylic acid groups to epoxy or oxirane functionality in polyfunctional epoxides of from about 3:1 to about 1:3, preferably from 2:1 to 1:1.8, more particularly from 1.2:1 to 1:1.2. Generally, the nature and amount of polyfunctional epoxides and/or reaction conditions can be optimized to obtain epoxy resin-based compositions with a density of cross-linking which are appropriate for PSA products.

Another embodiment disclosed herein is a method for making a PSA comprising: (a) polymerizing at least one dibasic acid with at least one epoxide having at least two epoxy groups, one diol or polyol, or one diamine, at a stoichiometric molar excess of reactive carboxylic acid groups relative to reactive epoxy groups, hydroxyl groups or amine groups to produce a thermoplastic prepolymer or oligomer capped with a carboxylic acid group at both prepolymer or oligomer chain ends, or a thermoplastic branched (which may be hyperbranched) prepolymer or oligomer with at least two of the prepolymer or oligomer branches and chain ends capped with a carboxylic acid group; and (b) curing the resulting thermoplastic prepolymer or oligomer with at least one polyfunctional epoxide, optionally under heating, to produce a PSA, wherein the polyfunctional epoxide is not an epoxidized vegetable oil. In one embodiment, a prepolymer is produced by polymerization (a). In another embodiment, an oligomer is produced by polymerization (a). The thermoplastic prepolymer or oligomer produced in polymerization (a) may have a molecular weight (number average molecular weight) of no higher than 100,000, preferably no higher than 50,000, more particularly no higher than 20,000. A further embodiment disclosed herein is a PSA construct comprising: (a) a backing substrate; and (b) a PSA composition disposed on the backing substrate, wherein the PSA composition includes a thermoplastic polymer made by reacting the carboxylic acid-capped prepolymer or oligomer with at least one polyfunctional epoxide, optionally under heating, wherein the polyfunctional epoxide is not an epoxidized vegetable oil.

The thermoplastic prepolymer or oligomer is capped with carboxylic acid groups at both chain ends, prepared via polymerization of a molar excess of at least one dibasic acid, or anhydride thereof, with at least one diepoxy, diol or diamine. In certain embodiments, pre-polymerization of a molar excess of dibasic acid, or anhydride thereof, with at least one epoxide having at least two epoxy groups, one diol or polyol, or one diamine can result in thermoplastic branched or hyperbranched polymers or oligomers with at least two of the branches and chain ends capped with carboxylic acid groups. For example, one branch and one chain end may each be capped with a carboxylic acid group. In another example, two or more branches may each be capped with a carboxylic acid group. In a further example, no branches but each chain end may be capped with a carboxylic acid group. By careful selection of the monomer pairs, design of the monomer feed ratio, and optimization of the reaction conditions and operations, a rich array of thermoplastic branched or hyperbranched polymers or oligomers with at least two of the branches and chain ends capped with carboxylic acid groups can be obtained.

Still another embodiment disclosed herein is a method for making a PSA comprising: (a) polymerizing at least one dibasic acid or anhydride thereof with at least one epoxide having at least two epoxy or oxirane groups at a stoichiometric molar excess of reactive epoxy or oxirane groups relative to reactive carboxylic acid groups to produce a thermoplastic epoxy prepolymer or oligomer capped with an epoxy or oxirane group at both prepolymer or oligomer chain ends, or a thermoplastic branched (which may be hyperbranched) prepolymer or oligomer with at least two of the prepolymer or oligomer branches and chain ends capped with an epoxy or oxirane group; and (b) curing the resulting thermoplastic epoxy prepolymer or oligomer with at least one polybasic acid, optionally under heating, to produce a PSA. In one embodiment, a prepolymer is produced by polymerization (a). In another embodiment, an oligomer is produced by polymerization (a). The thermoplastic epoxy prepolymer or oligomer produced in step (a) may have a molecular weight (number average molecular weight) of no higher than 100,000, preferably no higher than 50,000, more particularly no higher than 20,000. A further embodiment disclosed herein is a PSA construct comprising: (i) a backing substrate; and (ii) a PSA composition disposed on the backing substrate, wherein the PSA composition includes a thermoplastic epoxy polymer made from reacting at least one thermoplastic epoxy prepolymer or oligomer prepared in step (a) with at least one polybasic acid, optionally under heating.

The thermoplastic epoxy prepolymer or oligomer is capped with oxirane or epoxy functionality at both chain ends, prepared via polymerization of a molar excess of at least one diepoxy with at least one dibasic acid or anhydride thereof. In certain embodiments, pre-polymerization of at least one epoxide having at least two epoxy groups with at least one dibasic acid or anhydride thereof can result in thermoplastic branched or hyperbranched prepolymers or oligomers with at least two of the branches and chain ends capped with oxirane or epoxy groups. For example, one branch and one chain end may each be capped with an epoxy or oxirane group. In another example, two or more branches may each be capped with an oxirane or epoxy group. In a further example, no branches but each chain end may be capped with an oxirane or epoxy group. By careful selection of the monomer pairs, design of the monomer feed ratio, and optimization of the reaction conditions and operations, a rich array of thermoplastic branched or hyperbranched polymers or oligomers with at least two of the branches and chain ends capped with epoxy or oxirane groups can be obtained.

An additional embodiment disclosed herein is a method for making a PSA comprising: (a) polymerizing at least one dibasic acid or anhydride thereof with at least one epoxide having at least two epoxy or oxirane groups at a stoichiometric molar excess of reactive epoxy or oxirane groups relative to reactive carboxylic acid groups to produce a thermoplastic epoxy prepolymer or oligomer capped with an epoxy or oxirane group at both prepolymer or oligomer chain ends, or a thermoplastic branched (which may be hyperbranched) prepolymer or oligomer with at least two of the prepolymer or oligomer branches and chain ends capped with an epoxy or oxirane group; and (b) thermally curing the resulting thermoplastic epoxy prepolymer or oligomer to produce a PSA. In one embodiment, a prepolymer is produced by polymerization (a). In another embodiment, an oligomer is produced by polymerization (a). The curing reaction can be carried out at a temperature suitably in the range from 20 to 300° C., preferably from 60 to 220° C., and more particularly from 80 to 180° C. The thermoplastic epoxy prepolymer or oligomer produced in step (a) may have a molecular weight (number average molecular weight) of no higher than 100,000, preferably no higher than 50,000, more particularly no higher than 20,000. A further embodiment disclosed herein is a PSA construct comprising: (i) a backing substrate; and (ii) a PSA composition disposed on the backing substrate, wherein the PSA composition includes at least one thermoplastic epoxy polymer prepared in step (b).

In these embodiments, various thermoplastic prepolymers or oligomers are first synthesized via non-stoichiometrically-balanced polymerizations of dibasic acids or their anhydride derivatives with one epoxide having at least two epoxy or oxirane groups, one diol or polyol, or one diamine, followed by curing the resulting thermoplastic prepolymers or oligomers to produce PSA compositions. The above polymerizations can be carried out at a temperature suitably in the range from 20 to 300° C. for 1 to 180 minutes, preferably from 60 to 220° C. for 2 to 120 minutes, and more particularly from 80 to 180° C. for 5 to 60 minutes, to a degree that the minor functionality (i.e., reactive functional group that is present in less than a stoichiometric amount) is almost completely consumed. If desired, the polymerization is preferably carried out under an inert atmosphere free from oxygen (e.g., under nitrogen). Complete consumption of epoxy or carboxylic acid groups can be confirmed by checking the disappearance of characteristic signal at ca 916 cm⁻¹ or 1700 cm⁻¹ for epoxy and carboxylic acid groups, respectively, in the FTIR spectra. The molar ratio of carboxylic acid groups in the dibasic acids to epoxy or oxirane groups, hydroxyl groups, or amine groups in the epoxides, diols or polyols, or diamines, respectively, is important to the polymerizations, since it governs the nature of the terminal monomeric units, molecular weight and viscosity of the resulting epoxy resins. The molar ratio should be higher than one to ensure that the resulting prepolymers or oligomers are capped with carboxylic acid or epoxy groups at both chain ends; but it should be no less than 1.0001, particularly 1.005, more particularly no less than 1.02, and preferably from 1.005 to 100, more particularly from 1.02 to 20, so as to control the molecular weight and viscosity of the resulting prepolymers or oligomers.

After the non-stoichiometrically-balanced polymerizations, the thermoplastic prepolymers or oligomers capped with carboxylic acid or epoxy groups at both chain ends, or the thermoplastic branched or hyperbranched prepolymers or oligomers with at least two of the prepolymers or oligomer branches and chain ends capped with carboxylic acid or epoxy groups, further react with curing agents polyfunctional epoxides or polybasic acids, respectively, at a temperature suitably in the range from 30 to 300° C. for 1 to 120 minutes, preferably from 60 to 220° C. for 3 to 60 minutes, and more particularly from 80 to 180° C. for 4 to 30 minutes, to a degree that cross-linking does not obviously occur, and the viscosity of the intermediate reaction mixture is appropriate for blade-coating. If desired, the reaction is preferably carried out under an inert atmosphere free from oxygen, e.g., under nitrogen. The compositions may have an open time of up to about 5 or 180 minutes, depending on the nature and amount of the curing agents (polyfunctional epoxides or polybasic acids), the viscosity and functionality (epoxy or carboxylic acid group) density of the reaction mixture, reaction temperature, and the nature and amount of catalysts used, etc. As used herein, “open time” denotes the time from mixing the thermoplastic epoxy resins with curing agents to the time at which cross-linking takes place and viscosity greatly increases to a point that the mixed composition can no longer be applied. Polyfunctional epoxides can be used in molar ratios of epoxy or oxirane functionality present in the polyfunctional epoxides to carboxylic acid groups present in the thermoplastic carboxylic acid-capped prepolymers or oligomers of from about 3:1 to about 1:3, preferably from 1.8:1 to 1:2, more particularly from 1.2:1 to 1:1.2. Likewise, polybasic acids or anhydride derivatives thereof can be used in molar ratios of carboxylic acid groups present in the polybasic acid to epoxy or oxirane functionality present in the thermoplastic epoxy prepolymers or oligomers of from about 3:1 to about 1:3, preferably from 2:1 to 1:1.8, more particularly from 1.2:1 to 1:1.2. Generally, the nature and amount of the curing agents and/or reaction conditions can be optimized to obtain epoxy resin-based compositions with appropriate density of cross-linking which are appropriate for PSA products.

In some particular embodiments, some thermoplastic epoxy prepolymers or oligomers capped with epoxy groups at both chain ends, or thermoplastic branched or hyperbranched prepolymers or oligomers with at least two of the prepolymers or oligomer branches and chain ends capped with epoxy groups, prepared via non-stoichiometrically-balanced polymerizations can be cured in the absence of curing agents like polybasic acids, since the thermoplastic epoxy prepolymers or oligomers obtain via the pre-polymerization can further polycondensate to give polymers which have a higher molecular weight and can be physically crosslinked at room temperature due to a hard segment provided by certain “hard” carboxylic acids and/or epoxides such as bisphenol A diglycidyl ether or bisphenol F diglycidyl ether. Said “hard” monomers like “hard” carboxylic acids and “hard” epoxides are those usually used to prepare polymers characterized by high glass transition temperatures (e.g., higher than 80° C.); they usually contain heterocycle or aryl groups like phenyl in their structure. At the same time, the thermoplastic epoxy prepolymers or oligomers capped with oxirane or epoxy functionality can be cross-linked or cured possibly via polymerization of the excess oxirane or epoxy functionality in the thermoplastic epoxy resins under appropriate conditions. In these particular embodiments, the polycondensation or curing reactions of the thermoplastic epoxy prepolymers or oligomers can take place on release liners (e.g., siliconized release liners), backing materials, or between release liners (see the “thin-layer reactor” technology below for details).

In certain embodiments, the only PSA-forming reactive components of the final reaction mixture are (i) the polyfunctional epoxide, (ii) the carboxylic acid-capped thermoplastic epoxy prepolymer or oligomer, and optionally, a catalyst. In certain embodiments, the only PSA-forming reactive components of the final reaction mixture are (i) the polybasic acid, (ii) the epoxy-capped thermoplastic epoxy prepolymer or oligomer, and optionally, a catalyst. In certain embodiments, the only PSA-forming reactive components of the final reaction mixture are the epoxy-capped thermoplastic epoxy prepolymer or oligomer, and optionally, a catalyst.

The dibasic acids used in the preparation of the PSAs may include any compound that contains at least two carboxylic acid functional groups, and derivatives or analogs thereof. Compounds that include at least two displaceable active hydrogen atoms per molecule but the hydrogen atoms are not part of a carboxylic acid moiety are also considered to be dibasic acids from the viewpoint of polycondensation chemistry. For example, the “displaceable active hydrogen atoms” can be part of hydroxyl groups (—OH), amine groups (—NHR and —NH₂), or thiol groups (—SH), sulfonamides, etc. More than one dibasic acid can be utilized in a single mixture if desired.

Dibasic acids can be aliphatic (linear, branch or cyclic) saturated carboxylic acids containing up to 30 carbon atoms, preferably 2 to 22 carbon atoms, e.g., oxalic acid, malonic acid, itaconic acid, succinic acid, glutaric acid, adipic acid, pimelic acid, suberic acid, azelaic acid, sebacic acid, brassylic acid, and docosanedioic acid. Dibasic acids may also be aromatic acids and derivatives thereof, including without limitation, phthalic acid, isophthalic acid and terephthalic acid. Dibasic acid can also be produced from other derivatives such as anhydrides. Specific examples include without limitation succinic anhydride, itaconic anhydride, and phthalic anhydride. From the viewpoint of polycondensation chemistry, tribasic or higher H-functionality acids can also be considered to be “dibasic acids”. Tribasic or higher H-functionality acids include without limitation, 1,2,3,4-butanetetracarboxylic acid, ethylenediamine tetraacetic acid, citric acid, trimellitic acid, trimellitic anhydride, trimer acids, polymerized fatty acids, etc. Those obtained or derived from renewable raw materials are preferred, e.g., dimer acid, trimer acids, polymerized fatty acids, and citric acid. Citric acid is a tribasic organic acid, existing in a variety of fruits and vegetables, most notably citrus fruits. It is a commodity chemical produced and consumed throughout the world; the global production of citric acid in 2007 was over 1.6 million tons, and the world demand is still in rapid increasing (see, e.g., “citric acid production” by M. Berovic and M. Legisa (Biotechnol. Annu. Rev. 2007).

The dibasic acids or anhydride derivatives are preferably derived from natural resources. In addition to the high energy-consuming traditional processes for the production of dibasic acids, alternative accesses to various dibasic acids from renewable feedstocks have been well reported (see, e.g, “Lipids as renewable resources: current state of chemical and biotechnological conversion and diversification” by J. O. Metzger and U. Bornscheuer (Appl. Microbiol. Biotechnol. 2006)). For example, illustrative dibasic acids from natural renewable resources include a dimer acid, a trimer acid, and/or a polymerized fatty acid. These compounds may contain two or more carboxylic acid functional groups per molecule, which include without limitation, dimer acids, trimer acids, polymerized fatty acids (including their saturated forms obtained via hydrogenation), or mixtures thereof. Dimer acids, or dimerized fatty acids, are dicarboxylic acids that may be prepared by dimerizing unsaturated fatty acids, usually on clay catalysts (e.g., montmorillonite clay). Likewise, trimer acids and polymerized fatty acids are corresponding products where the resulting molecules consist of three and more fatty acid molecules, respectively. Although trimer acids and polymerized fatty acids consist of three and more carboxylic acid groups, respectively, they can also be considered to be “dibasic acids” from the viewpoint of polycondensation chemistry. Tall oil fatty acids (consisting mainly of oleic and linoleic acids) and other fatty acids from vegetable oils (e.g., erucic acid, linolenic acid), marine oils or tallow (e.g., high oleic tallow) can be starting materials to prepare dimer acids, trimer acids and polymerized fatty acids or mixtures thereof. (see, e.g, “Preparation of Meadowfoam Dimer Acids and Dimer Esters and Their Use as Lubricants” by D. A. Burg and R. Kleiman (JAOCS. 1991), “Fats and oils as oleochemical raw materials” by K. Hill (Pure Appl. Chem. 2000)). The fact that “dibasic acids” like dimer acids, trimer acids or polymerized fatty acids can be produced or derived from vegetable oil means that the PSA composition may be made entirely from renewable sources.

In certain embodiments, the dimer acid is a dimer of an unsaturated fatty acid or a mixture of the dimer and a small amount (up to 10 weight percent) of a monomer or trimer of the unsaturated fatty acid. The trimer acid is a timer of an unsaturated fatty acid or a mixture of the trimer and a small amount (up to 10 weight percent) of a monomer or dimer of the unsaturated fatty acid. A polymerized fatty acid contains four or more unsaturated fatty acid residues. The dimer acid, trimer acid or polymerized fatty acid may be a mixture of dimerized, trimerized or polymerized unsaturated fatty acids. Preferable unsaturated fatty acids include carboxylic acids having 12 to 24 carbon atoms and at least one unsaturated bond per molecule. Preferable acids having one unsaturated bond include, for example, oleic acid, elaidic acid and cetoleic acid. Preferable fatty acids having two unsaturated bonds include sorbic acid and linoleic acid. Preferable fatty acid having three or more of unsaturated bonds include linoleinic acid and arachidonic acid. The dimer acid, trimer acid, or polymerized fatty acid may be partially or fully hydrogenated. Illustrative dimer acids have the structure:

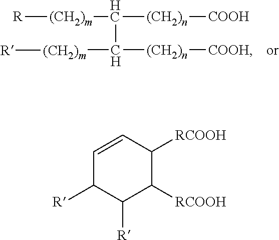

where R and R′ are the same or different, saturated, unsaturated or polyunsaturated, straight or branched alkyl groups having from 1 independently to 30 carbon atoms, and n, m, n′ and m′ are the same or different, ranging from 0 to 20. There may be more than one C—C crosslink between the monofunctional carboxylic acid moieties. Alternatively, R and R′ are the same or different, saturated, unsaturated or polyunsaturated, straight alkyl groups having from 1 independently to 20 carbon atoms, or having from 1 independently to 8 carbon atoms; n and m are the same or different, ranging from 1 independently to 10, or ranging from 4 independently to 16. In other non-limiting embodiments R may be butyl and R′ may be octyl; n may be 8 and m may be 14.

In another embodiment, the dimer acid may have the definition found in U.S. Pat. No. 3,287,273, incorporated herein in its entirety by reference. Such commercial dimer acids are generally produced by the polymerization of unsaturated C₁₈ fatty acids to form C₃₆ dibasic dimer acids. Depending on the raw materials used in the process, the C₁₈ monomeric acid may be linoleic acid or oleic acid or mixtures thereof. The resulting dimer acids may therefore be the dimers of linoleic acid, oleic acid or a mixture thereof.

Illustrative dimer acids include:

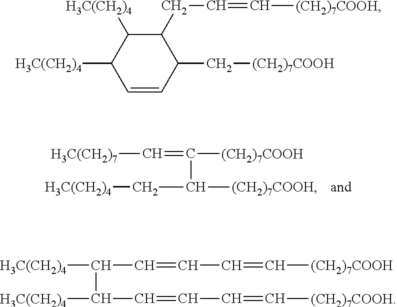

The structure of the trimer acids and polymerized fatty acids include three and more unsaturated fatty acid residues. They can be reaction products between unsaturated fatty acids, dimer acids thereof, and/or trimer acids and polymerized fatty acids thereof, via Diels-Alder and/or radical mechanism.

Epoxides used in the preparation of the PSAs disclosed herein may include any compound that contains at least two oxirane or epoxy functional groups, and derivatives or analogs thereof. More than one epoxide can be utilized in a single reaction mixture if desired. Epoxides can be glycidyl-containing compounds or epoxidized compounds having at least two epoxy groups. Examples of glycidyl-containing compounds include aliphatic diglycidyls such as an alkyl diglycidyl ether or an alkyl diglycidyl ester, or aromatic diglycidyls such as bisphenol diglycidyl ether. Examples of epoxides include without limitation, bisphenol A diglycidyl ether, bisphenol A ethoxylate diglycidyl ether, bisphenol A propoxylate diglycidyl ether, bisphenol F diglycidyl ether, bisphenol F ethoxylate diglycidyl ether, bisphenol F propoxylate diglycidyl ether, ethylene glycol diglycidyl ether, diethylene glycol diglycidyl ether, poly(ethylene glycol) diglycidyl ether, propylene glycol diglycidyl ether, dipropylene glycol diglycidyl ether, poly(propylene glycol) diglycidyl ether, 1,3-butanediol diglycidyl ether, 1,4-butanediol diglycidyl ether, neopentyl glycol diglycidyl ether, glycerol diglycidyl ether, diglycidyl 1,2,3,6-tetrahydrophthalate, 1,2-cyclohexanedicarboxylate diglycidyl ether, dimer acid diglycidyl ester, 1,4-cyclohexanedimethanol diglycidyl ether, resorcinol diglycidyl ether, poly(dimethylsiloxane) terminated with diglycidyl ether, and epoxidized fatty acid esters having two epoxy functional groups like epoxidized linoleic acid ester. In certain embodiments, compounds having more than two epoxy-functionalities are also considered to be difunctional epoxides from the viewpoint of polycondensation chemistry, which include without limitation, trimethylolpropane triglycidyl ether, trimethylolethane triglycidyl ether, N,N-diglycidyl-4-glycidyloxyaniline, 4,4′-methylene bis(N,N-diglycidylaniline), tris(4-hydroxyphenyl)methane triglycidyl ether, tris(2,3-epoxypropyl) cyanurate, tris(2,3-epoxypropyl) isocyanurate, epoxidized polybutadiene, epoxidized fatty acid esters having more than two epoxy functional groups like epoxidized linolenic acid ester, etc.

Illustrative repeating units for the prepolymers or oligomers described above derived from diepoxides or polyepoxides are represented as follows:

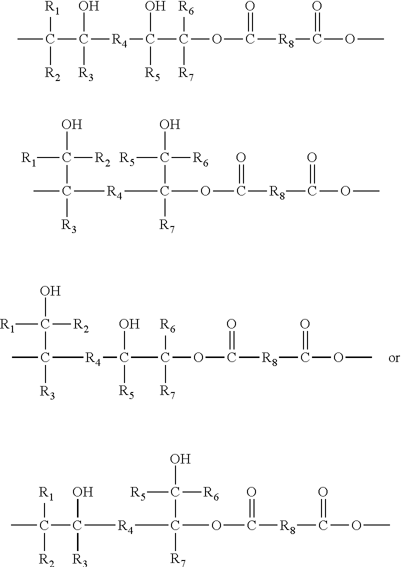

wherein each of R₁, R₂, R₃, R₄, R₅, R₆, R₇, and R₈ independently represents hydrogen or a substituted or unsubstituted alkyl or heteroalkyl group.

Illustrative diols (or glycols) include without limitation, ethylene glycol, 1,4-butanediol, 1,5-pentanediol, 1,8-octanediol, 1,2-propanediol, 1,2-butanediol, 2,3-butanediol, 1,3-butanedio-1,1,2-pentanediol, ethohexadiol, p-menthane-3,8-diol, 2-methyl-2,4-pentanediol, etc. Illustrative polyols include without limitation, glycerin, trimethylolpropane, pentaerythritol, maltitol, sorbitol, xylitol, and isomalt.

An illustrative repeating unit for the pre-polymers or oligomers described above derived from diols is represented as follows:

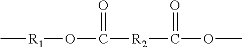

wherein each of R₁ and R₂ independently represents hydrogen or a substituted or unsubstituted alkyl or heteroalkyl group.

Illustrative diamines include without limitation, 1,2-diaminoethane, 1,3-diaminopropane, butane-1,4-diamine, pentane-1,5-diamine, hexane-1,6-diamine, 1,2-diaminopropane, diphenylethylenediamine, diaminocyclohexane, o-xylylenediamine, m-xylylenediamine, p-xylylenediamine, o-phenylenediamine, m-phenylenediamine, p-phenylenediamine, 2,5-diaminotoluene, dimethyl-4-phenylenediamine, N,N′-di-2-butyl-1,4-phenylenediamine, 4,4′-diaminobiphenyl, 1,8-diaminonaphthalene, and other compounds having two or more primary amino groups (—NH₂).

An illustrative repeating unit for the pre-polymers or oligomers described above derived from diamines is represented as follows:

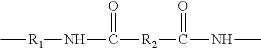

wherein, each of R₁ and R₂ independently represents hydrogen or a substituted or unsubstituted homoalkyl or heteroalkyl group.

In some particular embodiments, polybasic acids, or anhydrides thereof, are used to cure at elevated temperatures the thermoplastic epoxy prepolymers or oligomers capped with oxirane or epoxy functionality at both chain ends, or the thermoplastic branched or hyperbranched prepolymers or oligomers with at least two of the prepolymer or oligomer branches and chain ends capped with epoxy or oxirane groups, to make PSA compositions. Polybasic acids may contain three or more carboxylic acid functional groups in a molecule. The following are also considered to be polybasic acids from the viewpoint of chemistry: tribasic or higher H-functionality acids; and compounds that include two or more displaceable active hydrogen atoms per molecule but the hydrogen atoms are not part of a carboxyl moiety. For example, the “displaceable active hydrogen atoms” can be part of hydroxyl groups (—OH), amine groups (—NHR and —NH₂), thiol groups (—SH), sulfonamides, etc. Polybasic acids include without limitation, 1,2,3,4-butanetetracarboxylic acid, ethylenediamine tetraacetic acid, citric acid, trimellitic acid, trimellitic anhydride, trimer acids, polymerized fatty acids, etc. Those obtained or derived from renewable raw materials are preferred, e.g., trimer acids, polymerized fatty acids, and citric acid.

In other particular embodiments, polyfunctional epoxides are used to cure at elevated temperatures the thermoplastic prepolymers or oligomers capped with carboxylic acid groups at both chain ends, or the thermoplastic branched or hyperbranched prepolymers or oligomers with at least two of the prepolymer or oligomer branches and chain ends capped with carboxylic acid groups, to make PSA compositions. Polyfunctional epoxides include compounds having three or more epoxy functional groups per molecule. The polyfunctional epoxides include without limitation, trimethylolpropane triglycidyl ether, trimethylolethane triglycidyl ether, N,N-diglycidyl-4-glycidyloxyaniline, 4,4′-methylene bis(N,N-diglycidylaniline), tris(4-hydroxyphenyl)methane triglycidyl ether, tris(2,3-epoxypropyl) cyanurate, tris(2,3-epoxypropyl) isocyanurate, poly(ethylene-co-glycidyl methacrylate), epoxy functionalized polybutadiene, and epoxidized fatty acid esters having no less than three epoxy functional groups, like epoxidized linolenic acid ester, etc.

The important fact that the epoxides, dibasic acids, and in some embodiments polyfunctional epoxides and polybasic acids, can all be obtained or derived from natural resources makes the presently disclosed compositions entirely renewable PSAs.

In addition to the epoxides, dibasic acids, and in some embodiments polyfunctional epoxides and polybasic acids, the reaction mixtures can also contain from about 0.05 to 10.0, more particularly 0.1 to 10.0, preferably from about 0.1 to 2 parts by weight of a catalyst, based on the weight of the reactants, especially when the reaction is performed at low temperatures (e.g., <120° C.). The catalysts accelerate the polymerizations of epoxides with dibasic acids, and reduce the cure time of the thermoplastic epoxy resins in the presence of curing agents. Catalysts used to effectively catalyze the reaction between carboxylic acid groups or anhydride groups and epoxy groups can be employed for this purpose:

(1) amines, especially tertiary amines, —examples include but are not limited to, triethylamine, trimethylamine, tri-n-pentylamine, trioctylamine, tridecylamine, tridodecylamine, trieicosylamine, docosyldioctylamine, triacontyldibutylamine, 2-ethylhexyl di-n-propylamine, isopropyl di-n-dodecylamine, isobutyl di-n-eicosylamine, 2-methyldocosyl di-(2-ethylhexyl) amine, triacontyl di-(2-butyldecyl) amine, n-octadecyl di-(n-butyl)amine, n-eicosyl di-(n-decyl)amine, n-triacontyl n-dodecylmethylamine, n-octyldimethylamine, n-decyldiethylamine n-dodecyldiethylamine, n-octadecyldimethylamine, n-eicosyl dimethylamine, n-octyl n-dodecylmethylamine, n-decyl n-eicosylethylamine, n-octyldimethylamine, n-decyldimethylamine, n-dodecyldimethylamine, n-tetradecyldimethylamine, n-hexadecyldimethylamine, n-octadecyldimethylamine, n-eicosyldimethylamine, di-(n-octyl)methylamine, di-(n-decyl)methylamine, di-(n-dodecyl)methylamine, di-(n-tetradecyl)methylamine, di-(n-hexadecyl)methylamine, di-(n-octadecyl)methylamine,

di-(n-eicosyl)methylamine, n-octyl n-dodecylmethylamine, n-decyl n-octadecylmethylamine, dimethylbenzylamine, N,N-dimethylaniline, N,N-dimethylaniline, N-methyldiphenylamine, triphenylamine, N-methyl-N-dodecylaniline pyridine, 2-methylpyridine, triethanolamine, N-methylmorpholine, N-methylpiperidine, N-ethylpiperidine, N,N-dimethylpiperazine, 1-methyl imidazole, 1-butylimidazole, 1,8-diazabicyclo[5.4.0]undec-7-ene, 1,5-diazabicyclo[5.4.0]undec-5-ene, 1,5-diazabicyclo[4.3.0]non-5-ene, 1,4-diazobicyclo[2.2.2]-octane, tetramethyl guanidine, N,N,N′,N′-tetramethyl-1,8-diaminonaphthalene, 2-phenyl-2-imidazoline, 2-ethylimidazole, bis(2-ethylhexyl)amine, etc;

(2) metal salts or complexes, —examples include but are not limited to, chromium (III) tris(acetylacetonate), chromium (III) 2-ethylhexanoate, AFC Accelerator AMC-2 (a 50 wt % solution of chromium (III) complex available from Ampac Fine Chemical LLC), chromium (III) hexanoate, chromium (III) octoate, chromium (III) stearate, chromium (III) naphthenate, 3,5-diisopropylsalicylato chromium (III) chelate, bis(3,5-diisopropylsalicylato)-monohydroxy chromium (III) chelate, zinc acetate, zinc acetate dihydrate, zinc acetylacetonate, zinc octoate, zinc laurate, zinc salicylate, zinc glycinate, zinc gluconate, zinc oleoylsarcosinoate, zinc naphthenate, zinc 2-ethylhexyl acid phosphate salt, zinc butyl acid phosphate salt, zinc di-2-ethylhexyldithio-phosphate, zinc salt of dodecenyl succinate butyl half ester, N-butylsalicylaldimio zinc (II) chelate, zinc isovalerate, zinc succinate, zinc dibutyl dithiocarbamate, stannous octoate, stannum (II) 2-ethylhexyl acid phosphate salt, titanium ethyl acetoacetate chelate, titanium acetoacetate chelate, titanium triethanolamine chelate, zirconium octoate, zirconium 6-methylhexanedione, zirconium (IV) trifluoroacetylacetone, 3,5-diisopropylsalicylato nickel (II) chelate, nickel acetylacetonate, N-butylsalicylaldimio nickel (II) chelate, 3,5-diisopropylsalicylato manganese (II) chelate, manganese naphthenate, manganese naphthenate, magnesium 2,4-pentadionate, iron octoate, ferric linoleate, iron (III) acetylacetonate, cobalt octoate, cobalt naphthenate, cobalt (III) acetylacetonate, N-butylsalicylaldimio cobalt (II) chelate, N-butylsalicylaldimio cobalt (III) chelate, 3,5-diisopropylsalicylato cobalt (II) chelate, N-butylsalicylaldimio copper (II) chelate, 3,5-diisopropylsalicylato copper (II) chelate, 3,5-diisopropylsalicylato oxyvanadium (IV) chelate, aluminum acetylacetonate, aluminum lactate, dibutyltin dilaurate, dibutyltin oxide, butylchloro tin dihydroxide, cerium naphthenate, calcium octoate, bismuth octoate, lithium acetate, sodium acetate, potassium acetate, etc;

(3) quaternary ammonium compounds, —examples include but are not limited to, tetrabutyl ammonium bromide, tetrabutyl ammonium iodide, tetrabutyl ammonium hydrogen sulphate, tetrabutyl ammonium fluoride, tetrabutyl ammonium chloride, tetraethyl ammonium bromide, tetraethylammonium iodide, tetrapropylammonium bromide, tetrapropyl ammonium iodide, tetramethyl ammonium chloride, tetramethylammonium bromide, tetramethyl ammonium iodide, tetraoctyl ammonium bromide, benzyltriethyl ammonium chloride, benzyltributyl ammonium chloride, benzyltrimethyl ammonium chloride, benzyltrimethylammonium bromide, butyltriethyl ammonium bromide, methyltrioctyl ammonium chloride, methyltricapryl ammonium chloride, methyltributyl ammonium chloride, methyltributyl ammonium bromide, methyltriethyl ammonium chloride, myristyltrimethyl ammonium bromide, tetradecyltrimethyl ammonium bromide, cetyltrimethyl (or hexadecyltrimethyl) ammonium bromide, hexadectyltrimethyl ammonium bromide, cetyltrimethylammonium chloride, hexadectyltrimethyl ammonium chloride, lauryltrimethyl ammonium chloride, dodecyltrimethyl ammonium chloride, phenyltrimethyl ammonium chloride, benzalkonium chloride, cetyldimethylbenzyl ammonium bromide, cetalkonium bromide, cetyldimethylbenzyl ammonium chloride, cetalkonium chloride, tetrabutyl ammonium perchlorate, tetrabutyl ammonium p-toluene sulfonate, tetraethyl ammonium p-toluene sulfonate, cetyltrimethyl ammonium p-toluene sulfonate, tetraethyl ammonium tosylate, tetrabutyl ammonium tosylate, cetyltrimethyl ammonium tosylate, phenyltrimethyl ammonium bromide, benzyltrimethyl ammonium hydroxide, tetrabutyl ammonium hydroxide, tetramethyl ammonium hydroxide, etc;

(4) quaternary phosphonium compounds, —examples include but are not limited to, tetrabutyl phosphonium bromide, ethyltriphenyl phosphonium iodide, ethyltriphenyl phosphonium bromide, ethyltriphenyl phosphonium iodide, butyltriphenyl phosphonium bromide, benzyltriphenyl phosphonium chloride, methyltriphenyl phosphonium bromide, methyltriphenyl phosphonium iodide, tetraphenyl phosphonium bromide, triphenyl phosphonium bromide, methyltriphenyl phosphonium chloride, butyl triphenyl phosphonium chloride, (methoxy methyl)triphenyl phosphonium chloride, etc;

(5) phosphines, examples include but are not limited to, triphenylphosphine, etc;

(6) alkali metal hydroxide, e.g. potassium hydroxide, sodium hydroxide, etc.

The catalysts may be added at any point during the polymerization from the initial charge until the coating of the reaction mixtures. In certain embodiments, it is preferred and important that the catalyst be dissolved in one of the reactants, preferably in dibasic acids, prior to the polymerization.

In particular embodiments, the final polymerization products (i.e., the final cured epoxy polymers) disclosed herein are the majority component of the PSA composition meaning the PSA composition includes at least about 50, particularly at least about 70, more particularly at least about 80, and most particularly at least about 90, weight percent of the cured epoxy polymers based on the total weight of the PSA composition. The PSA compositions may also include additives and fillers. Fillers may either originally occur in the starting materials such as esters of fatty acids, or be added as needed. Additives such as tackifiers, colored pigments, opacifiers, processing oils, plasticizers, solvents and other constituents known to the tape art may be incorporated in the PSAs.

Polymerization of dibasic acids or its anhydride derivatives with difunctional or polyfunctional epoxides may be accomplished by heating the reaction mixture under controlled conditions, especially reaction temperature and time. The reaction mixtures can be admixed together through at least two methods: (1) dibasic acids (component a), difunctional or polyfunctional epoxides (component b), and optionally catalysts are mixed together at room temperature prior to heating; or (2) component a (or component b) is mixed with catalysts at room temperature or elevated temperatures to give a homogeneous solution, followed by the addition of component b (or component a) which may be previously melted to a liquid state by heating.

In particular embodiments, the pre-polymerization of dibasic acids or its anhydride derivatives with polyfunctional epoxides, or the reaction of curing agents with the thermoplastic prepolymers or oligomers prepared via non-stoichiometrically-balanced polymerizations of dibasic acids or its anhydride derivatives and epoxides having at least two epoxy groups, diols or polyols, or diamines, are accomplished by heating the reaction mixtures to a desirable extent that the reaction mixtures turn homogenous, cross-linking does not obviously occur (i.e., within the open time of the reaction mixture), and the viscosity of the epoxy resins is appropriate to allow blade-coating onto release liners (e.g., siliconized release liners) or PSA backing materials. For example, the viscosity should be no higher than 2,000,000 mPa·s, preferably no higher than 200,000 mPa·s, more particularly no higher than 100,000 mPa·s, at operating temperatures and stirring speeds. The PSA backing materials can be paper, cellophane, plastic film (e.g., bi-axially oriented polypropylene(BOPP) film, polyvinylchloride (PVC) film), cloth, tape or metal foils. Generally, the reaction mixtures can be blade-coated on siliconized release liners or PSA backing substrates with a glass bar immediately after mixing well the reaction mixtures, with the result that a thin, uniform layer of the mixtures is produced on the backing materials or liners at a coating level of about 0.5 to about 10 mg/cm². However, in some particular embodiments, in order to increase the viscosity of the reaction mixtures for good coatability, the pre-polymerizations of dibasic acids or anhydride derivatives thereof with polyfunctional epoxides, or the reactions between the thermoplastic epoxy resins and curing agents are allowed to take place prior to coating to a desirable degree such that an appropriate viscosity of the mixture is reached but cross-linking does not obviously occur. In other particular embodiments, the curing agents per se are powdery solid with a fairly high melting point; they are preferably dissolved under heating and stirring into the thermoplastic epoxy resins prior to coating and curing.

The resulting coated compositions on the liners or backing materials are then heated such as in an air-circulating oven, infrared oven, or tunnel oven so that appropriate cross-linking of the epoxy resins can take place to give a “dry” adhesive layer of sufficient cohesion strength, good initial tack and adhesive power that are appropriate for PSA applications. According to some particular embodiments, the resulting adhesive coatings on the PSA backings are subjected to heat such as in an air-circulating oven maintained at 100-300° C. for 10 seconds to 100 minutes, preferably at 120-250° C. for 30 seconds to 80 minutes, and more particularly at 150-200° C. for 1 to 60 minutes. Generally, the higher the reaction temperature the shorter the duration of heating is needed to accomplish the curing reaction. However, it should be noted that the heat stability of the PSA backing or siliconized release liners should be considered before choosing the oven temperature. On the other hand, at higher temperatures, both epoxy groups and hydroxyl groups derived from the carboxyl-epoxy reaction may react with carboxylic acid or anhydride groups. As the curing reaction proceeds further, the carboxylic acid-hydroxyl esterification reaction may dominate the reaction, with the result that the density of cross-linking increases and the resulting composition becomes less appropriate for PSA application. Although cross-linking is desirable for PSA applications, particularly where it is desired to increase the cohesive strength of the adhesive without unduly affecting its compliance, too high density of cross-linking can be deleterious to the PSA properties, with a severe loss of compliance as reflected in the peel test. Therefore, the reaction temperature at this stage should be finely tuned for appropriate cross-linking of the PSA systems.

The PSA composition can also be coated on a release liner and covered with a sheet of backing material, resulting in a sandwich assembly which is then pressed (e.g., with a rubber roller) to achieve sufficient wet-out of the adhesive onto the PSA backing. Subsequently, the release liner is removed from the sandwich assembly, with the adhesive transferring onto the PSA backing. The resulting adhesive coatings on the backing are then heated such as in an air-circulating oven so that appropriate cross-linking of the thermoplastic epoxy resin can take place to give a dry adhesive layer of sufficient cohesion strength, good initial tack and adhesive power that are appropriate for a PSA. It should be noted that, the coating composition layer on the backing substrate after heating might not have a good appearance, with blotches of no or little adhesive on the backing substrate, probably due to shrinkage of the adhesive composition during the polymerization and curing reaction. To address this issue, a novel technology, viz. “thin-layer reactor” technology was developed and applied to the PSA systems. The intermediate polymer product is initially blade-coated on the siliconized face of siliconized release liners; the resulting adhesive coatings on the siliconized release liners are then covered with a sheet of PSA backing material or another sheet of release liner, resulting in the sandwich assembly functioning as “thin-layer reactor.”

In some particular embodiments, the sandwich assembly consisting of a release liner and the backing material as a whole may be heated to cure the PSA composition and then the release liner may be removed. In other particular embodiments, the preparation of a PSA composition and PSA products comprising the composition could be performed with the aid of two siliconized release liners with different adhesion-repellence ability to the final adhesive composition. The pre-polymerization mixture is initially blade-coated on the siliconized face of a sheet of partially siliconized release liner; the resulting adhesive coating is then covered with a sheet of fully siliconized release liner (with the siliconized face inwardly), resulting in a sandwich assembly which is pressed (e.g., with a rubber roller) to achieve a good contact between the adhesive composition and the two liners. A “partially” siliconized release liner means that the release liner surface is partially covered by a silicone agent; a “fully” siliconized release liner means that the release liner surface is substantially covered by a silicone agent, leading to better adhesion-repellence ability to the adhesive composition than “partially” siliconized release liner. The sandwich assembly is then heated such as in an air-circulating oven so that appropriate cross-linking of the polymers can take place to give a dry adhesive layer of sufficient cohesion strength, good initial tack and adhesive power that are appropriate for PSA application. Afterwards, the fully siliconized release liner is quickly peeled off without taking away any adhesive composition, after which a sheet of backing material such as paper, BOPP film, or PVC film is immediately and carefully covered on the adhesive layer. The new “sandwich” is then pressed (e.g., with a rubber roller) to achieve sufficient wet-out of the adhesive onto the backing material in order to provide adequate adhesion. After the sandwich assembly is cooled down, the partially siliconized release liner could be easily peeled off with the adhesive composition completely transferring to the backing material. In these embodiments, a first release liner, e.g., the partially siliconized release liner has an adhesion-repellence to the final adhesive composition less than that of a second release liner, e.g., the fully siliconized release liner. In other words, the second release liner can be more easily removed than the first release liner meaning that one release liner can be removed while the PSA composition still adheres to another release liner. The siliconized released liner can be optionally left for protection of the adhesive layers on the backing material. Advantages for this technology include without limitation, (1) shrinkage of the PSA composition can be considerably avoided, (2) low molecular weight starting materials for making the PSA composition are avoided to penetrate the paper backing to give oily or dirty appearance of the resulting PSA tape, and (3) in the cases that materials of low Heat Distortion Temperature and/or inferior thermal stability (such as PP and PVC) are used as PSA backing materials, subjection to oven heating at high temperatures (e.g., 160° C.) can be avoided.

According to particular embodiments, the disclosed PSAs may be used to manufacture many different types of PSA tapes. Thus, various flexible tape backings and liners may be used, including films (transparent and non-transparent), plastics such as PET film, BOPP and PVC film or modified natural substances such as cellophane, cloths, papers, non-woven fibrous constructions, metal foils, metalized plastics foils, aligned filaments, etc. The adhesive layers can be covered with papers or films which contain an adhesive-repellent layer, e.g. a separating layer consisting of silicone, for the protection of the adhesive layers on the PSA backings. The back side of the PSA films, tapes or foils can be coated with an adhesive-repellent coating (e.g., silicone coating) for facilitating rolling off the PSA.

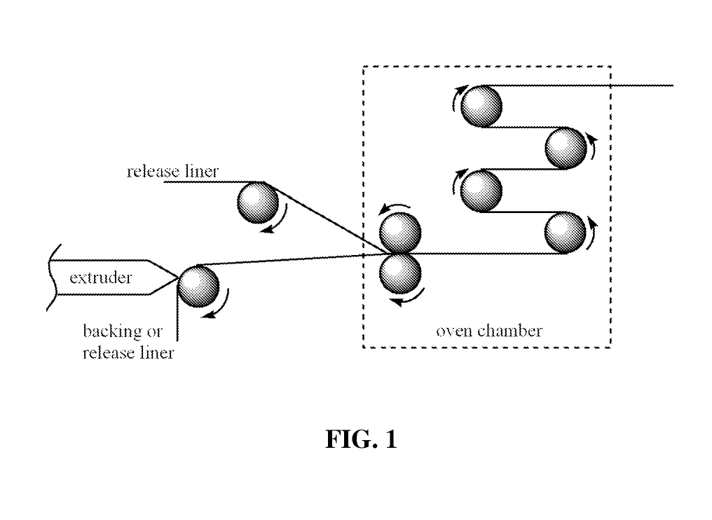

In particular embodiments, the preparation of the PSA compositions and PSA tapes thereof as disclosed herein could be continuously performed using a combination of reactive extrusion and reactive calendaring, which is illustrated in FIG. 1. The reactive calendaring setup is a device that includes a series of rollers placed in an oven chamber. In some embodiments, the rollers may be unheated and disposed of inside an oven chamber at a preset temperature. In other embodiments, heated rollers can be used and the whole calendaring setup does not need to be housed in an oven chamber. As shown in FIG. 1, the pre-polymerizations or curing reactions are done continuously using reactive extrusion in a mono- or twin-screw extruder. The final epoxy resin-based compositions from the extruder are thereupon coated on backing materials (e.g., film or paper) or release liners, which are then laminated with other release liners with different adhesion ability to the adhesive compositions, to give a sandwich assembly. Afterwards, the sandwich assembly is directed to heated calendar rollers or calendar rolls placed in an oven chamber at a preset temperature. The duration of the process can be fine-tuned by adjusting the number and sizes of the rolls or the travel distance of the assembly inside the oven chamber, so that appropriate cross-linking of the polyesters can take place to give a dry adhesive layer of sufficient cohesion strength, good initial tack and adhesive power that are appropriate for PSA.

The novel epoxy resin-based PSA compositions and the method of making them and the PSA products thereof are attractive from both the commercial and environmental perspectives. The advantages of these novel PSAs include without limitation, (1) the starting materials can partially or totally originate from naturally abundant and renewable resources, providing an alternative to petrochemical-based PSAs, (2) the products are fully or partially biodegradable, thus alleviating environmental pollution by used PSA-containing products, and (3) the novel PSA compositions and PSA products thereof are made without using any organic solvent, or additives such as tackifiers and waxes that are commonly used in many commodity petrochemical-based PSAs, therefore, the whole process is environmentally friendly.

### Example 1

This example describes the preparation of a PSA composition from trimethylolpropane triglycidyl ether (TMPGE, epoxy equivalent weight (EEW) ˜138) and dimer acid (hydrogenated; available from Aldrich; average Mₙ ˜570, dimer acid ≧98%, monomer ≦1%, trimer acid ≦1%) in a molar ratio of 0.96:1 oxirane groups to carboxylic acid groups in the presence of AFC Accelerator AMC-2 (AMC-2; 4.75 grams per mole of carboxylic acid groups; a 50 wt % solution of chromium (III) complex, available from Ampac Fine Chemical, LLC), and of PSA tapes comprising the composition with the aid of two siliconized release liners with different adhesion-repellence property for the adhesive composition.

AMC-2 (0.098 g) and dimer acid (5.88 g, containing 20.6 mmol of carboxylic acid groups) were charged to a 50-mL, round-bottom flask equipped with a silicon oil bath and magnetic stirrer, and heated up to 80° C. by the preheated oil bath with stirring to give a clear, light green, viscous solution. To the solution, TMPGE (2.73 g, containing about 19.8 mmol of oxirane groups) was then added, and the resulting mixture was bubbled with nitrogen for two minutes. Afterwards, heating and stirring (400 rpm) were continued for 66 minutes at the same temperature to give a homogeneous, light green, viscous resin. The resin was then quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 5 minutes in the oven. The fully siliconized released liner was easily peeled off without taking away any adhesive composition, and a sheet of paper backing was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA thus obtained possessed good initial tack, formed ropy structure upon removal of it from surfaces (e.g., metal, lacquer, glass, human skin) to which they are applied, and exhibited a good adhesive power of about 1.5 lbf/inch on stainless steel (type 302). The 90° peel adhesion test procedure and conditions are described below; the sample was cleanly removed in the test, leaving no adhesive residue on the panel. The experimental conditions and 90° peel adhesion test results are shown in Table 1.

This following procedure describes 90° peel adhesion test on stainless steel for all of the sample tapes. The measure of bond strength between an adhesive and a substrate is defined as adhesion, which is typically obtained using the 90° peel adhesion test method by measuring the force required to remove the pressure-sensitive material from a stainless steel, at an angle of 90°, and at a specified speed of 12 inches/minute, according to ASTM D3330/D3330M-04 (2010). The tests are performed on an Instron 5582 testing machine at 23±1° C. and 50±5% RH. An exemplary 90° peel adhesion test of sample tapes on a stainless steel test panel (type 302 stainless steel, 2 by 5 inches) consists of following steps:
(1) Clean the test panel three times with acetone and Kimwipe-Clark wipers, and condition the panel for about 10-12 minutes before applying the tape onto the panel.
(2) Randomly cut 5 strips of specimens from each PSA-coated sample sheet. The size of the specimens is 1 by 12 inches.
(3) Fold approximately 0.5 inch at one end of the specimen, adhesive to adhesive to form a tab. Touch other end of the specimen to an end of the test panel, with the adhesive side down against the stainless steel test panel. Hold the folded end of the specimen so that it does not make contact with the panel but is positioned loosely above it. Press the specimen by two passes of a 4.5-pound hard rubber roller in the direction parallel to the panel length, to achieve sufficient wet-out onto the panel surface in order to provide adequate adhesion.
(4) The pasted specimen tape was allowed to dwell for 1 minute prior to testing.
(5) Set up and calibrate the testing machine in accordance with the manufacture instructions. A five-pound load cell was used.
(6) Double back the folded end of the specimen tape at a 90° angle and peel 1 inch of it from the panel. Place the folded end of the specimen onto the upper jaw of the testing machine, and start testing. The speed of the moving jaw for the peel test was 12 inches/minute. While the upper jaw was moving up, the panel was passively moved in the horizontal direction along the holder so that the specimen tape maintained a peel angle of 90° throughout the test.
(7) Data were collected after the first inch of specimen tape was peeled, and average peel adhesion strength in pounds was obtained for peeling the rest of the tape.
(8) Repeat the above steps to test the other four strips of specimen, and average the results.

TABLE 1^{a}

| | | | | 2^{nd} stage of pre- | | | | | |
|---|---|---|---|---|---|---|---|---|---|
| | | | | polymerization | | | | | |
| | 1^{st} stage of | | | curing | | | | 160° C. | |
| | pre-polymerization | | | agent, | | | AMC-2 | cure | peel |
| | acid, epoxide; | temp. | time | molar | temp. | time | (g/mol- | time | strength^{d} |
| Examples^{b} | oxirane/COOH | (° C.) | (min) | ratio^{c} | (° C.) | (min) | COOH) | (min) | (lbf/inch) |
| 1 | DA, TMPGE | 80 | 66 | — | — | — | 4.75 | 5 | 1.5 |
| | 0.96 | | | | | | | | |
| 2 | DA, TMPGE | 80 | 11 | — | — | — | 4.69 | 7 | 0.8 |
| | 0.96 | | | | | | | | |
| 3 | DA, TMPGE | 80 | 11 | — | — | — | 4.69 | 8 | 0.8 |
| | 0.96 | | | | | | | | |
| 4 | DA, PBDE | 80 | 34 | — | — | — | 4.53 | 12 | 1.4 |
| | 0.87 | | | | | | | | |
| 5 | DA, BPAGE | 150 | 69 | TMPGE | 80 | 4 | 4.38 | 10 | 2.4 |
| | 0.401 | | | 0.503 | | | | | |
| 6 | DA, BPAGE | 150 | 69 | TMPGE | 85 | 35 | 4.35 | 4 | 3.3 |
| | 0.422 | | | 0.549 | | | | | |
| 7 | DA, BPAGE | 150 | 69 | TMPGE | 85 | 35 | 4.35 | 10 | 1.5 |
| | 0.422 | | | 0.549 | | | | | |
| 8 | DA, DADGE | 80 | 46 | MBDGA | 80 | 12 | 4.96 | 4 | 2.0 |
| | 0.472 | | | 0.502 | | | | | |
| 9 | DA, DADGE | 80 | 49 | TEPIC | 100 | 18 | 4.97 | 11 | 3.4 |
| | 0.466 | | | 0.447 | | | | | |
| 10^{e} | DA, DADGE | 80 | 60 | TEPIC | 100 | 9 | 5.03 | 7 | 2.6 |
| | 0.468 | | | 0.449 | | | | | |
| 11 | DA, DADGE | 80 | 60 | TEPIC | 100 | 9 | 5.03 | 7 | 2.5 |
| | 0.468 | | | 0.449 | | | | | |
| 12 | DA, NPGGE | 160 | 102 | BTCA | 160 | 65 | 4.59 | 18 | 2.8 |
| | 1.24 | | | 0.298 | | | | | |
| 13 | SA, NPGGE | 120 | 70 | CA | 160 | 56 | 3.98 | 20 | 2.1 |
| | 1.28 | | | 0.320 | | | | | |
| 14 | DA, NPGGE | 160 | 75 | CAH | 100-160^{f} | 115 | 7.75 | 25 | 3.4 |
| | 1.25 | | | 0.219 | | | | | |
| 15 | DA, NPGGE | 160 | 75 | CA | 160 | 27 | 7.68 | 38 | 2.0 |
| | 1.26 | | | 0.218 | | | | | |
| 16 | DA, NPGGE | 160 | 75 | CA | 160 | 27 | 7.68 | 43 | 2.1 |
| | 1.26 | | | 0.218 | | | | | |
| 17 | DA, PEGGE | 120 | 34 | CA | 120 | 5 | 6.85 | 12 | 1.8 |
| | 1.38 | | | 0.380 | | | | | |
| 18 | DA, BPFGE | 80 | 32 | — | — | — | 5.00 | 19 | 2.6 |
| | 1.22 | | | | | | | | |

^{a}abbreviations:
DA, dimer acid (hydrogenated; available from Aldrich; average Mₙ ~570, dimer acid ≧98%, monomer ≦1%, trimer acid ≦1%);
TMPGE, trimethylolpropane triglycidyl ether (epoxy equivalent weight, or EEW, 138;
PBDE, epoxy functionalized polybutadiene (hydroxyl terminated; EEW, 260);
BPAGE, bisphenol A diglycidyl ether (EEW, 173);
DADGE, dimer acid diglycidyl ester (EEW, 430);
MBDGA, 4,4′-methylene bis(N,N-diglycidylaniline) (EEW, 109);
TEPIC, tris(2,3-epoxypropyl) isocyanurate (Aldrich, 98%);
NPGGE, neopentyl glycol diglycidyl ether (EEW, 143);
BTCA, 1,2,3,4-butanetetracarboxylic acid (Aldrich, 99%);
CA, citric acid (anhydrous; Aldrich, 99%);
CAH, citric acid (monohydrate; Aldrich, 99%);
SA, sebacic acid (Aldrich, 98%);
PEGGE, poly(ethylene glycol) diglycidyl ether (EEW, 264);
BPFGE, bisphenol F diglycidyl ether (EEW, 160).
^{b}PSA backing materials are paper, except that bi-axially oriented polypropylene film is used as backing material in Examples 2, 6, 10 and 15, and that PVC film is used as backing material in Examples 3, 7, 11 and 16.
^{c}molar ratio of the reactive groups from the added curing agents to those from the dibasic acids or epoxides which are in excess in the 1^{st} stage of the pre-polymerization.
^{d}the 90° peel adhesion test method, procedure and conditions are described in Example 1; the sample adhesives were cleanly removed in the test, leaving no adhesive residue on the panel.
^{e}the shear time to failure tests were also performed at 23° C. on a stainless steel (type 302) substrate in accordance with ASTM D3654/D3654M-06 (2006), using a 1000 gram test mass and ½ inch times ½ inch testing area. And a shear time to failure of 50 minutes was recorded.
^{f}the polymerization took place first at 100° C. for 80 minutes and then at 160° C. for another 35 minutes.

### Example 2

This example describes the preparation of a PSA composition from TMPGE (EEW ˜138) and dimer acid (hydrogenated; available from Aldrich; average Mₙ ˜570, dimer acid ≧98%, monomer ≦1%, trimer acid ≦1%) in a molar ratio of 0.96:1 oxirane groups to carboxylic acid groups in the presence of AMC-2 (4.69 grams per mole of carboxylic acid groups), and of PSA tapes (BOPP film as backing material) comprising the composition with the aid of two siliconized release liners with different adhesion-repellence property for the adhesive composition.

AMC-2 (0.144 g) and dimer acid (8.75 g) were charged to a 50-mL, round-bottom flask equipped with a silicon oil bath and magnetic stirrer, and heated up to 80° C. by the preheated oil bath with stirring to give a clear, light green, viscous solution. To the solution, TMPGE (4.091 g) was then added, and the resulting mixture was bubbled with nitrogen for two minutes. Afterwards, heating and stirring (200 rpm) were continued for 11 minutes at the same temperature to give a homogeneous, light green, viscous resin. The resin was then quickly blade-coated on the siliconised face of a sheet of partially siliconized release liner with a glass rod at a coating level of about 5 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 7 minutes in the oven. The fully siliconized released liner was easily peeled off without taking away any adhesive composition; a sheet of BOPP film was immediately and carefully covered on the adhesive layer. The new “sandwich” was then pressed with a rubber roller to achieve sufficient wet-out of the adhesive onto the BOPP backing in order to provide adequate adhesion. After the “sandwich” was cooled down, the partially siliconized release liner could be peeled off with the adhesive composition being completely transferred to the BOPP backing. The siliconized release liner can be optionally left for the protection of the adhesive layers on the BOPP backing or be recovered for re-use. The adhesive coating on the BOPP backing was a thin, clear, pale yellowish green, shiny, uniform, “dry” adhesive layer of sufficient cohesion strength. The finished PSA tape thus obtained possessed good initial tack, formed ropy structure upon removal of it from surfaces (e.g. metal, lacquer, glass, human skin) to which they are applied, and exhibited a good adhesive power of about 0.8 lbf/inch on stainless steel (type 302). The 90° peel adhesion test method and conditions are described in Example 1; the sample was cleanly removed in the test, leaving no adhesive residue on the panel. The experimental conditions and 90° peel adhesion test results are shown in Table 1.

### Example 3

This example describes the preparation of a PSA composition from TMPGE (EEW ˜138) and dimer acid (hydrogenated; available from Aldrich; average Mₙ ˜570, dimer acid ≧98%, monomer ≦1%, trimer acid ≦1%) in a molar ratio of 0.96:1 oxirane groups to carboxylic acid groups in the presence of AMC-2 (4.69 grams per mole of carboxylic acid groups), and of PSA tapes (PVC film as backing material) comprising the composition with the aid of two siliconized release liners with different adhesion-repellence property for the adhesive composition.

AMC-2 (0.144 g) and dimer acid (8.75 g) were charged to a 50-mL, round-bottom flask equipped with a silicon oil bath and magnetic stirrer, and heated up to 80° C. by the preheated oil bath with stirring to give a clear, light green, viscous solution. To the solution, TMPGE (4.091 g) was then added, and the resulting mixture was bubbled with nitrogen for two minutes. Afterwards, heating and stirring (200 rpm) were continued for 11 minutes at the same temperature to give a homogeneous, light green, viscous resin. The resin was then quickly blade-coated on the siliconised face of a sheet of partially siliconized release liner with a glass rod at a coating level of about 5 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 8 minutes in the oven. The fully siliconized released liner was easily peeled off without taking away any adhesive composition; a sheet of PVC film was immediately and carefully covered on the adhesive layer. The new “sandwich” was then pressed with a rubber roller to achieve sufficient wet-out of the adhesive onto the PVC backing in order to provide adequate adhesion. After the “sandwich” was cooled down, the partially siliconized release liner could be peeled off with the adhesive composition being completely transferred to the PVC backing. The siliconized release liner can be optionally left for the protection of the adhesive layers on the PVC backing or be recovered for re-use. The adhesive coating on the PVC backing was a thin, clear, pale yellowish green, shiny, uniform, “dry” adhesive layer of sufficient cohesion strength. The finished PSA tape thus obtained possessed good initial tack, formed ropy structure upon removal of it from surfaces (e.g. metal, lacquer, glass, human skin) to which they are applied, and exhibited a good adhesive power of about 0.8 lbf/inch on stainless steel (type 302). The 90° peel adhesion test method and conditions are described in Example 1; the sample was cleanly removed in the test, leaving no adhesive residue on the panel. The experimental conditions and 90° peel adhesion test results are shown in Table 1.

### Example 4

This example describes the preparation of a PSA composition from epoxy functionalized polybutadiene (hydroxyl terminated, abbreviated as PBDE, Mₙ ˜1300, epoxy equivalent weight (EEW) ˜260) and dimer acid (hydrogenated; available from Aldrich; average Mₙ ˜570, dimer acid ≧98%, monomer ≦1%, trimer acid ≦1%) in a molar ratio of 0.87:1 oxirane groups to carboxylic acid groups in the presence of AMC-2 (4.53 grams per mole of carboxylic acid groups), and of PSA tapes comprising the composition with the aid of two siliconized release liners with different adhesion-repellence property for the adhesive composition.

AMC-2 (0.056 g), PBDE (2.81 g, containing about 10.8 mmol of oxirane groups) and dimer acid (3.43 g, containing 12.4 mmol of carboxylic acid groups) were charged to a 50-mL, round-bottom flask equipped with a silicon oil bath and magnetic stirrer. The resulting mixture was bubbled with nitrogen for two minutes, and then sealed and heated up to 80° C. by the preheated oil bath with stirring. Heating was continued with stirring at 400 rpm for 34 minutes at this temperature to give a homogeneous, light green, viscous resin. The resin was then quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 12 minutes in the oven. The fully siliconized released liner was easily peeled off without taking away any adhesive composition, and a sheet of paper backing was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA thus obtained possessed good initial tack, formed ropy structure upon removal of it from surfaces (e.g., metal, lacquer, glass, human skin) to which they are applied, and exhibited a good adhesive power of about 1.4 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 5

This example describes the preparation of a PSA composition from dimer acid (hydrogenated; available from Aldrich; average Mₙ ˜570, dimer acid ≧98%, monomer ≦1%, trimer acid ≦1%), bisphenol A diglycidyl ether (BPAGE, EEW ˜172), and TMPGE in a molar ratio of 0.90:1 total oxirane groups to carboxylic acid groups, in the presence of AMC-2 (4.38 grams per mole of carboxylic acid groups), and of PSA tapes comprising the composition with the aid of two siliconized release liners with different adhesion-repellence property for the adhesive composition.

AMC-2 (0.057 g) and dimer acid (3.70 g, containing 13.0 mmol of carboxylic acid groups) were charged to a 50-mL, round-bottom flask equipped with a silicon oil bath and magnetic stirrer, and heated up to 150° C. by the preheated oil bath with stirring to give a clear, light green, viscous solution. To the solution, BPAGE (0.906 g, containing about 5.2 mmol of oxirane groups) was then added, and the resulting mixture was bubbled with nitrogen for two minutes. Afterwards, heating and stirring (400 rpm) were continued for 69 minutes at the same temperature to give a homogeneous, light green, viscous resin. After the mixture was cooled to 80° C., TMPGE (0.903 g, containing about 6.5 mmol of oxirane groups) was added, and heating and stirring (300 rpm) were continued for another 4 minutes at the same temperature to give a homogeneous, light green, viscous resin. The resin was then quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 10 minutes in the oven. The fully siliconized released liner was easily peeled off without taking away any adhesive composition; a sheet of paper was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA tape thus obtained possessed good initial tack, formed ropy structure upon removal of it from surfaces (e.g., metal, lacquer, glass, human skin) to which they are applied, and exhibited a good adhesive power of about 2.4 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 6

This example describes the preparation of a PSA composition from dimer acid (hydrogenated; available from Aldrich; average Mₙ ˜570, dimer acid ≧98%, monomer ≦1%, trimer acid ≦1%), BPAGE (EEW ˜173) and TMPGE in a molar ratio of 0.97:1 total oxirane groups to carboxylic acid groups, in the presence of AMC-2 (4.35 grams per mole of carboxylic acid groups), and of PSA tapes (BOPP film as backing material) comprising the composition with the aid of two siliconized release liners with different adhesion-repellence property for the adhesive composition.

AMC-2 (0.156 g), dimer acid (10.25 g) and BPAGE (2.626 g) were charged to a 50-mL, round-bottom flask equipped with a silicon oil bath and magnetic stirrer. The resulting mixture was bubbled with nitrogen for two minutes, and then sealed and heated up to 150° C. by the preheated oil bath with stirring. Heating was continued with stirring at 200 rpm for 69 minutes at this temperature to give a homogeneous, light green resin. After the mixture was cooled to 85° C., TMPGE (2.722 g) was added to the mixture, and heating and stirring (200 rpm) were continued for another 35 minutes at the same temperature to give a homogeneous, light green, viscous resin. The resin was then quickly blade-coated on the siliconised face of a sheet of partially siliconized release liner with a glass rod at a coating level of about 5 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 4 minutes in the oven. The fully siliconized released liner was easily peeled off without taking away any adhesive composition; a sheet of BOPP film was immediately and carefully covered on the adhesive layer. The new “sandwich” was then pressed with a rubber roller to achieve sufficient wet-out of the adhesive onto the BOPP backing in order to provide adequate adhesion. After the “sandwich” was cooled down, the partially siliconized release liner could be peeled off with the adhesive composition being completely transferred to the BOPP backing. The siliconized release liner can be optionally left for the protection of the adhesive layers on the BOPP backing or be recovered for re-use. The adhesive coating on the BOPP backing was a thin, clear, pale green, shiny, uniform, “dry” adhesive layer of sufficient cohesion strength. The finished PSA tape thus obtained possessed good initial tack, formed ropy structure upon removal of it from surfaces (e.g., metal, lacquer, glass, human skin) to which they are applied, and exhibited a very good adhesive power of about 3.3 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 7

This example describes the preparation of a PSA composition from dimer acid (hydrogenated; available from Aldrich; average Mₙ ˜570, dimer acid ≧98%, monomer ≦1%, trimer acid ≦1%), BPAGE (EEW ˜173) and TMPGE in a molar ratio of 0.97:1 total oxirane groups to carboxylic acid groups, in the presence of AMC-2 (4.35 grams per mole of carboxylic acid groups), and of PSA tapes (PVC film as backing material) comprising the composition with the aid of two siliconized release liners with different adhesion-repellence property for the adhesive composition.

AMC-2 (0.156 g), dimer acid (10.25 g) and BPAGE (2.626 g) were charged to a 50-mL, round-bottom flask equipped with a silicon oil bath and magnetic stirrer. The resulting mixture was bubbled with nitrogen for two minutes, and then sealed and heated up to 150° C. by the preheated oil bath with stirring. Heating was continued with stirring at 200 rpm for 69 minutes at this temperature to give a homogeneous, light green resin. After the mixture was cooled to 85° C., TMPGE (2.722 g) was added to the mixture, and heating and stirring (200 rpm) were continued for another 35 minutes at the same temperature to give a homogeneous, light green, viscous resin. The resin was then quickly blade-coated on the siliconised face of a sheet of partially siliconized release liner with a glass rod at a coating level of about 5 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 10 minutes in the oven. The fully siliconized released liner was easily peeled off without taking away any adhesive composition; a sheet of PVC film was immediately and carefully covered on the adhesive layer. The new “sandwich” was then pressed with a rubber roller to achieve sufficient wet-out of the adhesive onto the PVC backing in order to provide adequate adhesion. After the “sandwich” was cooled down, the partially siliconized release liner could be peeled off with the adhesive composition being completely transferred to the PVC backing. The siliconized release liner can be optionally left for the protection of the adhesive layers on the PVC backing or be recovered for re-use. The adhesive coating on the PVC backing was a thin, clear, pale green, shiny, uniform, “dry” adhesive layer of sufficient cohesion strength. The finished PSA tape thus obtained possessed good initial tack, formed ropy structure upon removal of it from surfaces (e.g., metal, lacquer, glass, human skin) to which they are applied, and exhibited a good adhesive power of about 1.5 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 8

This example describes the preparation of a PSA composition from dimer acid (hydrogenated; available from Aldrich; average Mₙ ˜570, dimer acid ≧98%, monomer ≦1%, trimer acid ≦1%), dimer acid diglycidyl ester (DADGE, EEW ˜430), and 4,4′-methylene bis(N,N-diglycidylaniline) (MBDGA, EEW ˜109) in a molar ratio of 0.97:1 total oxirane groups to carboxylic acid groups, in the presence of AMC-2 (4.96 grams per mole of carboxylic acid groups), and of PSA tapes comprising the composition with the aid of two siliconized release liners with different adhesion-repellence property for the adhesive composition.

AMC-2 (0.058 g), dimer acid (2.976 g, containing 10.4 mmol of carboxylic acid groups) and DADGE (2.391 g, containing about 5.56 mmol of oxirane groups and 1.39 mmol of carboxylic acid groups) were charged to a 50-mL, round-bottom flask equipped with a silicon oil bath and magnetic stirrer. The resulting mixture was bubbled with nitrogen for two minutes, and then sealed and heated up to 80° C. by the preheated oil bath with stirring. Heating was continued with stirring at 300 rpm for 46 minutes at this temperature to give a homogeneous, light green resin. Afterwards, MBDGA (0.456 g, containing about 4.51 mmol of oxirane groups) was added to the mixture, and heating and stirring (200 rpm) were continued for another 12 minutes at the same temperature to give a homogeneous, light green, viscous resin. The resin was then quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 4 minutes in the oven. The fully siliconized released liner was easily peeled off without taking away any adhesive composition; a sheet of paper was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA tape thus obtained possessed good initial tack, formed ropy structure upon removal of it from surfaces (e.g., metal, lacquer, glass, human skin) to which they are applied, and exhibited a good adhesive power of about 2.0 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 9

This example describes the preparation of a PSA composition from dimer acid (hydrogenated; available from Aldrich; average Mₙ ˜570, dimer acid ≧98%, monomer ≦1%, trimer acid ≦1%), dimer acid diglycidyl ester (DADGE, EEW ˜430), and tris(2,3-epoxypropyl) isocyanurate (TEPIC; Aldrich, 98%) in a molar ratio of 0.91:1 total oxirane groups to carboxylic acid groups, in the presence of AMC-2 (4.97 grams per mole of carboxylic acid groups), and of PSA tapes comprising the composition with the aid of two siliconized release liners with different adhesion-repellence property for the adhesive composition.

AMC-2 (0.050 g), dimer acid (2.541 g, containing 8.92 mmol of carboxylic acid groups) and DADGE (2.023 g, containing about 4.71 mmol of oxirane groups and 1.18 mmol of carboxylic acid groups) were charged to a 50-mL, round-bottom flask equipped with a silicon oil bath and magnetic stirrer. The resulting mixture was bubbled with nitrogen for two minutes, and then sealed and heated up to 80° C. by the preheated oil bath with stirring. Heating was continued with stirring at 400 rpm for 49 minutes at this temperature to give a homogeneous, light green resin. Afterwards, TEPIC (0.456 g, containing about 4.51 mmol of oxirane groups) was added to the mixture. The resulting mixture was heated up to 100° C. by the preheated oil bath with stirring, and heating and stirring (200 rpm) were continued for another 18 minutes at this temperature to give a homogeneous, light green, viscous resin. The resin was then quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 11 minutes in the oven. The fully siliconized released liner was easily peeled off without taking away any adhesive composition; a sheet of paper was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA tape thus obtained possessed good initial tack, formed ropy structure upon removal of it from surfaces (e.g., metal, lacquer, glass, human skin) to which they are applied, and exhibited a very good adhesive power of about 3.4 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 10

This example describes the preparation of a PSA composition from dimer acid (hydrogenated; available from Aldrich; average Mₙ ˜570, dimer acid ≧98%, monomer ≦1%, trimer acid ≦1%), DADGE (EEW ˜430) and TEPIC (Aldrich, 98%), in a molar ratio of 0.92:1 total oxirane groups to carboxylic acid groups, in the presence of AMC-2 (5.03 grams per mole of carboxylic acid groups), and of PSA tapes (BOPP film as backing material) comprising the composition with the aid of two siliconized release liners with different adhesion-repellence property for the adhesive composition.

AMC-2 (0.102 g), dimer acid (5.120 g) and DADGE (4.095 g) were charged to a 50-mL, round-bottom flask equipped with a silicon oil bath and magnetic stirrer. The resulting mixture was bubbled with nitrogen for two minutes, and then sealed and heated up to 80° C. by the preheated oil bath with stirring. Heating was continued with stirring at 200 rpm for 60 minutes at this temperature to give a homogeneous, light green resin. Afterwards, TEPIC (0.925 g) was added to the mixture. The resulting mixture was heated up to 100° C. by the preheated oil bath with stirring, and heating and stirring (200 rpm) were continued for another 9 minutes at this temperature to give a homogeneous, light green, viscous resin. The resin was then quickly blade-coated on the siliconised face of a sheet of partially siliconized release liner with a glass rod at a coating level of about 5 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 7 minutes in the oven. The fully siliconized released liner was easily peeled off without taking away any adhesive composition; a sheet of BOPP film was immediately and carefully covered on the adhesive layer. The new “sandwich” was then pressed with a rubber roller to achieve sufficient wet-out of the adhesive onto the BOPP backing in order to provide adequate adhesion. After the “sandwich” was cooled down, the partially siliconized release liner could be peeled off with the adhesive composition being completely transferred to the BOPP backing. The siliconized release liner can be optionally left for the protection of the adhesive layers on the BOPP backing or be recovered for re-use. The adhesive coating on the BOPP backing was a thin, clear, pale green, shiny, uniform, “dry” adhesive layer of sufficient cohesion strength. The finished PSA tape thus obtained possessed good initial tack, formed ropy structure upon removal of it from surfaces (e.g., metal, lacquer, glass, human skin) to which they are applied, and exhibited a good adhesive power of about 2.6 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

The shear time to failure for the above sample was determined to be 50 minutes according to the Standard Test Method for Shear Adhesion of PSA tapes; the mode of failure is adhesion failure, i.e., the sample was cleanly removed in the test, leaving no adhesive residue on the panel. The internal or cohesive strength of an adhesive film is known as shear. This is a measure of the internal strength of the adhesive itself. Shear properties are typically quantified using the static shear test method. The following procedure describes Standard Test for Shear Adhesion of Pressure-Sensitive Tapes in accordance with Procedure A of ASTM D3654/D3654M-06 (2006). The tests are performed at 23±1° C. and 50±5% RH on a stainless steel substrate (type 302, with bright annealed finish, 2 by 5 inches), using a 1000 gram test mass and ½ inch times ½ inch testing area. An exemplary shear adhesion test of sample tapes consists of following steps:
(1) Clean the test panel three times with acetone and Kimwipe-Clark wipers, and condition the panel for about 10-12 minutes before applying the tape onto the panel.
(2) Randomly cut 5 strips of specimens from each PSA-coated sample sheet. The size of the specimens is ½ inch in width.
(3) Center the test specimen at one end of the test panel and apply, without added pressure, to cover an area exactly ½ by ½ inch, with tape.
(4) Place hook on the free end of the tape specimen, ensuring that the hook extends completely across the width of the specimen and is aligned to uniformly distribute the load.
(5) Place the test assembly in the test stand so that the free end of the test specimen is vertical, ensuring that no peel forces act on the specimen.
(6) Individually prepare each specimen and test within one minute. To start the test, apply the 1000 g mass to the hook gently so as to cause no shear impact force on the tape specimen.
(7) Record the time elapse in which the tape specimen has separated completely from the test panel, and the mode of failure (cohesive failure or adhesion failure).
(8) Repeat the above steps to test the other two strips of specimen, and average the results.

### Example 11

This example describes the preparation of a PSA composition from dimer acid (hydrogenated; available from Aldrich; average Mₙ ˜570, dimer acid ≧98%, monomer ≦1%, trimer acid ≦1%), DADGE (EEW ˜430) and TEPIC (Aldrich, 98%), in a molar ratio of 0.92:1 total oxirane groups to carboxylic acid groups, in the presence of AMC-2 (5.03 grams per mole of carboxylic acid groups), and of PSA tapes (PVC film as backing material) comprising the composition with the aid of two siliconized release liners with different adhesion-repellence property for the adhesive composition.

AMC-2 (0.102 g), dimer acid (5.120 g) and DADGE (4.095 g) were charged to a 50-mL, round-bottom flask equipped with a silicon oil bath and magnetic stirrer.

The resulting mixture was bubbled with nitrogen for two minutes, and then sealed and heated up to 80° C. by the preheated oil bath with stirring. Heating was continued with stirring at 200 rpm for 60 minutes at this temperature to give a homogeneous, light green resin. Afterwards, TEPIC (0.925 g) was added to the mixture. The resulting mixture was heated up to 100° C. by the preheated oil bath with stirring, and heating and stirring (200 rpm) were continued for another 9 minutes at this temperature to give a homogeneous, light green, viscous resin. The resin was then quickly blade-coated on the siliconised face of a sheet of partially siliconized release liner with a glass rod at a coating level of about 5 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 7 minutes in the oven. The fully siliconized released liner was easily peeled off without taking away any adhesive composition; a sheet of PVC film was immediately and carefully covered on the adhesive layer. The new “sandwich” was then pressed with a rubber roller to achieve sufficient wet-out of the adhesive onto the PVC backing in order to provide adequate adhesion. After the “sandwich” was cooled down, the partially siliconized release liner could be peeled off with the adhesive composition being completely transferred to the PVC backing. The siliconized release liner can be optionally left for the protection of the adhesive layers on the PVC backing or be recovered for re-use. The adhesive coating on the PVC backing was a thin, clear, pale green, shiny, uniform, “dry” adhesive layer of sufficient cohesion strength. The finished PSA tape thus obtained possessed good initial tack, formed ropy structure upon removal of it from surfaces (e.g., metal, lacquer, glass, human skin) to which they are applied, and exhibited a good adhesive power of about 2.5 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 12

This example describes the preparation of a PSA composition from dimer acid (hydrogenated; available from Aldrich; average Mₙ ˜570, dimer acid ≧98%, monomer ≦1%, trimer acid ≦1%), neopentyl glycol diglycidyl ether (NPGGE, EEW ˜135), and 1,2,3,4-butanetetracarboxylic acid (BTCA; Aldrich, 99%) in a molar ratio of 0.91:1 oxirane groups to total carboxylic acid groups, in the presence of AMC-2 (4.59 grams per mole of carboxylic acid groups), and of PSA tapes comprising the composition with the aid of two siliconized release liners with different adhesion-repellence property for the adhesive composition.

AMC-2 (0.061 g), dimer acid (2.77 g, containing 9.7 mmol of carboxylic acid groups) and NPGGE (1.64 g, containing about 12.1 mmol of oxirane groups) were charged to a 50-mL, round-bottom flask equipped with a silicon oil bath and magnetic stirrer. The resulting mixture was bubbled with nitrogen for two minutes, and then sealed and heated up to 160° C. by the preheated oil bath with stirring. Heating was continued with stirring at 500 rpm for 102 minutes at this temperature to give a homogeneous, light green resin. Into the mixture, BTCA (0.21 g, containing 3.6 mmol of carboxylic acid groups) was added, and heating and stirring (500 rpm) were continued for another 65 minutes at the same temperature to give a homogeneous, light yellowish-green, viscous resin. The resin was then quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 18 minutes in the oven. The fully siliconized released liner was easily peeled off without taking away any adhesive composition; a sheet of paper was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA tape thus obtained possessed good initial tack, formed ropy structure upon removal of it from surfaces (e.g., metal, lacquer, glass, human skin) to which they are applied, and exhibited a very good adhesive power of about 2.8 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 13

This example describes the preparation of a PSA composition from sebacic acid (Aldrich, 98%), NPGGE (EEW ˜143), and citric acid (anhydrous; Aldrich, 99%) in a molar ratio of 0.91:1 oxirane groups to total carboxylic acid groups, in the presence of AMC-2 (3.98 grams per mole of carboxylic acid groups), and of PSA tapes comprising the composition with the aid of two siliconized release liners with different adhesion-repellence property for the adhesive composition.

AMC-2 (0.104 g), sebacic acid (1.91 g, containing 18.5 mmol of carboxylic acid groups) and NPGGE (3.19 g, containing about 23.6 mmol of oxirane groups) were charged to a 50-mL, round-bottom flask equipped with a silicon oil bath and magnetic stirrer. The resulting mixture was bubbled with nitrogen for two minutes, and then sealed and heated up to 120° C. by the preheated oil bath with stirring. Heating was continued with stirring at 500 rpm for 70 minutes at this temperature to give a homogeneous, light green resin. After the temperature of the mixture was raised to 160° C., citric acid (0.48 g, containing 7.6 mmol of carboxylic acid groups) was added, and heating and stirring (400 rpm) were continued for another 56 minutes at the same temperature to give a homogeneous, light-green, highly viscous resin. The resin was then quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 20 minutes in the oven. The fully siliconized released liner was easily peeled off without taking away any adhesive composition; a sheet of paper was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA tape thus obtained possessed good initial tack, formed ropy structure upon removal of it from surfaces (e.g., metal, lacquer, glass, human skin) to which they are applied, and exhibited a good adhesive power of about 2.1 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 14

This example describes the preparation of a PSA composition from dimer acid (hydrogenated; available from Aldrich; average Mₙ ˜570, dimer acid ≧98%, monomer ≦1%, trimer acid ≦1%), NPGGE (EEW ˜143), and CAH (citric acid monohydrate; Aldrich, 99%) in a molar ratio of 0.98:1 oxirane groups to total carboxylic acid groups, in the presence of AMC-2 (7.75 grams per mole of carboxylic acid groups), and of PSA tapes comprising the composition with the aid of two siliconized release liners with different adhesion-repellence property for the adhesive composition.

AMC-2 (0.093 g) and dimer acid (2.68 g, containing 9.4 mmol of carboxylic acid groups) were charged to a 50-mL, round-bottom flask equipped with a silicon oil bath and magnetic stirrer, and heated up to 160° C. by the preheated oil bath with stirring to give a clear, light green, viscous solution. To the solution, NPGGE (1.59 g, containing about 11.8 mmol of oxirane groups) was then added, and the resulting mixture was bubbled with nitrogen for two minutes. Afterwards, heating and stirring (300 rpm) were continued for 75 minutes at the same temperature to give a homogeneous, light green resin. After the mixture was cooled to 100° C., CAH (0.18 g, containing 2.6 mmol of carboxylic acid groups) was added, and heating and stirring (300 rpm) were continued for another 80 minutes at 100° C. and 35 minutes at 160° C. to give a homogeneous, light greenish-yellow, viscous resin. The resin was then quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 25 minutes in the oven. The fully siliconized released liner was easily peeled off without taking away any adhesive composition; a sheet of paper was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA tape thus obtained possessed good initial tack, formed ropy structure upon removal of it from surfaces (e.g., metal, lacquer, glass, human skin) to which they are applied, and exhibited a very good adhesive power of about 3.4 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 15

This example describes the preparation of a PSA composition from dimer acid (hydrogenated; available from Aldrich; average Mₙ ˜570, dimer acid ≧98%, monomer ≦1%, trimer acid ≦1%), NPGGE (EEW ˜143), and citric acid (Aldrich, 99%) in a molar ratio of 0.99:1 oxirane groups to total carboxylic acid groups, in the presence of AMC-2 (7.68 grams per mole of carboxylic acid groups), and of PSA tapes (BOPP film as backing material) comprising the composition with the aid of two siliconized release liners with different adhesion-repellence property for the adhesive composition.

AMC-2 (0.186 g), dimer acid (5.397 g) and NPGGE (3.229 g) were charged to a 50-mL, round-bottom flask equipped with a silicon oil bath and magnetic stirrer. The resulting mixture was bubbled with nitrogen for two minutes, and then sealed and heated up to 160° C. by the preheated oil bath with stirring. Heating was continued with stirring at 200 rpm for 75 minutes at this temperature to give a homogeneous, light green resin. Afterwards, citric acid (0.335 g) was added to the mixture, and heating and stirring (200 rpm) were continued for another 27 minutes at the same temperature to give a homogeneous, light green, viscous resin. The resin was then quickly blade-coated on the siliconised face of a sheet of partially siliconized release liner with a glass rod at a coating level of about 5 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 38 minutes in the oven. The fully siliconized released liner was easily peeled off without taking away any adhesive composition; a sheet of BOPP film was immediately and carefully covered on the adhesive layer. The new “sandwich” was then pressed with a rubber roller to achieve sufficient wet-out of the adhesive onto the BOPP backing in order to provide adequate adhesion. After the “sandwich” was cooled down, the partially siliconized release liner could be peeled off with the adhesive composition being completely transferred to the BOPP backing. The siliconized release liner can be optionally left for the protection of the adhesive layers on the BOPP backing or be recovered for re-use. The adhesive coating on the BOPP backing was a thin, clear, pale green, shiny, uniform, “dry” adhesive layer of sufficient cohesion strength. The finished PSA tape thus obtained possessed good initial tack, formed ropy structure upon removal of it from surfaces (e.g., metal, lacquer, glass, human skin) to which they are applied, and exhibited a very good adhesive power of about 2.0 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 16

This example describes the preparation of a PSA composition from dimer acid (hydrogenated; available from Aldrich; average Mₙ ˜570, dimer acid ≧98%, monomer ≦1%, trimer acid ≦1%), NPGGE (EEW ˜143), and citric acid (Aldrich, 99%) in a molar ratio of 0.99:1 oxirane groups to total carboxylic acid groups, in the presence of AMC-2 (7.68 grams per mole of carboxylic acid groups), and of PSA tapes (PVC film as backing material) comprising the composition with the aid of two siliconized release liners with different adhesion-repellence property for the adhesive composition.

AMC-2 (0.186 g), dimer acid (5.397 g) and NPGGE (3.229 g) were charged to a 50-mL, round-bottom flask equipped with a silicon oil bath and magnetic stirrer.

The resulting mixture was bubbled with nitrogen for two minutes, and then sealed and heated up to 160° C. by the preheated oil bath with stirring. Heating was continued with stirring at 200 rpm for 75 minutes at this temperature to give a homogeneous, light green resin. Afterwards, citric acid (0.335 g) was added to the mixture, and heating and stirring (200 rpm) were continued for another 27 minutes at the same temperature to give a homogeneous, light green, viscous resin. The resin was then quickly blade-coated on the siliconised face of a sheet of partially siliconized release liner with a glass rod at a coating level of about 5 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 43 minutes in the oven. The fully siliconized released liner was easily peeled off without taking away any adhesive composition; a sheet of PVC film was immediately and carefully covered on the adhesive layer. The new “sandwich” was then pressed with a rubber roller to achieve sufficient wet-out of the adhesive onto the PVC backing in order to provide adequate adhesion. After the “sandwich” was cooled down, the partially siliconized release liner could be peeled off with the adhesive composition being completely transferred to the PVC backing. The siliconized release liner can be optionally left for the protection of the adhesive layers on the PVC backing or be recovered for re-use. The adhesive coating on the PVC backing was a thin, clear, pale green, shiny, uniform, “dry” adhesive layer of sufficient cohesion strength. The finished PSA tape thus obtained possessed good initial tack, formed ropy structure upon removal of it from surfaces (e.g., metal, lacquer, glass, human skin) to which they are applied, and exhibited a very good adhesive power of about 2.1 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 17

This example describes the preparation of a PSA composition from dimer acid (hydrogenated; available from Aldrich; average Mₙ ˜570, dimer acid ≧98%, monomer ≦1%, trimer acid ≦1%), poly(ethylene glycol) diglycidyl ether (PEGGE; EEW ˜264), and citric acid (anhydrous; Aldrich, 99%), in a molar ratio of 0.90:1 oxirane groups to total carboxylic acid groups, in the presence of AMC-2 (6.85 grams per mole of carboxylic acid groups), and of PSA tapes comprising the composition with the aid of two siliconized release liners with different adhesion-repellence property for the adhesive composition.

AMC-2 (0.089 g), dimer acid (2.43 g, containing 8.5 mmol of carboxylic acid groups) and PEGGE (3.09 g, containing about 11.7 mmol of oxirane groups) were charged to a 50-mL, round-bottom flask equipped with a silicon oil bath and magnetic stirrer. The resulting mixture was bubbled with nitrogen for two minutes, and then sealed and heated up to 120° C. by the preheated oil bath with stirring. Heating was continued with stirring at 500 rpm for 34 minutes at this temperature to give a homogeneous, light green resin. Into the mixture, citric acid (0.28 g, containing 4.4 mmol of carboxylic acid groups) was added, and heating and stirring (500 rpm) were continued for another 5 minutes at the same temperature to give a homogeneous, light-green, highly viscous resin. The resin was then quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 12 minutes in the oven. The fully siliconized released liner was easily peeled off without taking away any adhesive composition; a sheet of paper was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA tape thus obtained possessed good initial tack, formed ropy structure upon removal of it from surfaces (e.g., metal, lacquer, glass, human skin) to which they are applied, and exhibited a good adhesive power of about 1.8 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

### Example 18

This example describes the preparation of a PSA composition from dimer acid (hydrogenated; available from Aldrich; average Mₙ ˜570, dimer acid ≧98%, monomer ≦1%, trimer acid ≦1%) and bisphenol F diglycidyl ether (BPFGE, EEW ˜160) in a molar ratio of 1.22:1 oxirane groups to carboxylic acid groups, in the presence of AMC-2 (5.00 grams per mole of carboxylic acid groups), and of PSA tapes comprising the composition with the aid of two siliconized release liners with different adhesion-repellence property for the adhesive composition.

AMC-2 (0.076 g) and dimer acid (3.70 g, containing 13.0 mmol of carboxylic acid groups) were charged to a 50-mL, round-bottom flask equipped with a silicon oil bath and magnetic stirrer, and heated up to 80° C. by the preheated oil bath with stirring to give a clear, light green, viscous solution. The resulting mixture was bubbled with nitrogen for two minutes; heating and stirring (400 rpm) were then continued for 32 minutes at the same temperature to give a homogeneous, light green, viscous resin. Afterwards, the resin was quickly blade-coated on the siliconised face of a sheet of partially siliconized release liner with a glass rod at a coating level of about 7 mg/cm², to give a thin, uniform layer of sticky, fiber-forming and “wet” coating layer. The adhesive layer was carefully covered with a sheet of fully siliconized release liner (the siliconized face inwardly), resulting in a “sandwich” which was then pressed with a rubber roller to achieve a good contact between the adhesive composition and the two liners. Subsequently, the “sandwich” was placed in an air-circulating oven maintained at 160° C., and taken out after 19 minutes in the oven. The fully siliconized released liner was easily peeled off without taking away any adhesive composition; a sheet of paper was immediately and carefully covered on the adhesive layer. The new “sandwich” was then pressed with a rubber roller to achieve sufficient wet-out of the adhesive onto the paper backing in order to provide adequate adhesion. After the “sandwich” was cooled down, the partially siliconized release liner could be peeled off with the adhesive composition being completely transferred to the paper backing. The siliconized release liner can be optionally left for the protection of the adhesive layers on the paper backing or be recovered for re-use. The adhesive coating on the paper backing was a thin, clear, pale green, shiny, uniform, “dry” adhesive layer of sufficient cohesion strength, and was not found to penetrate the paper backing or give an oily appearance of the PSA tape. The finished PSA tape thus obtained possessed good initial tack, formed ropy structure upon removal of it from surfaces (e.g., metal, lacquer, glass, human skin) to which they are applied, and exhibited a very good adhesive power of about 2.6 lbf/inch on stainless steel (type 302). The 90° peel adhesion test procedure and conditions are described in Example 1; the sample was cleanly removed in the test, leaving no adhesive residue on the panel. The experimental conditions and 90° peel adhesion test results are shown in Table 1.

In view of the many possible embodiments to which the principles of the disclosed invention may be applied, it should be recognized that the illustrated embodiments are only preferred examples of the invention and should not be taken as limiting the scope of the invention.

1. A method for making a pressure sensitive adhesive comprising:
(a) reacting at least one dibasic acid or anhydride thereof with at least one polyfunctional epoxide to produce a thermoplastic epoxy prepolymer or oligomer, wherein the polyfunctional epoxide is not an epoxidized vegetable oil; and
(b) thermally curing the resulting thermoplastic epoxy prepolymer or oligomer to produce a pressure sensitive adhesive.

2. A method for making a pressure sensitive adhesive comprising:
(a) reacting (i) at least one dibasic acid or anhydride thereof with (ii) at least one epoxide having at least two epoxy groups, at least one diol or polyol, or at least one diamine at a stoichiometric molar excess of reactive carboxylic acid groups relative to reactive epoxy groups, hydroxyl groups or amine groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group; and
(b) curing the resulting carboxylic acid-capped prepolymer or oligomer with at least one polyfunctional epoxide to produce a pressure sensitive adhesive, wherein the polyfunctional epoxide is not an epoxidized vegetable oil.

3. A method for making a pressure sensitive adhesive comprising:
(a) reacting at least one dibasic acid or anhydride thereof with at least one epoxide having at least two epoxy or oxirane groups at a stoichiometric molar excess of reactive epoxy or oxirane groups relative to reactive carboxylic acid groups to produce a thermoplastic prepolymer or oligomer capped with an epoxy or an oxirane group at both prepolymer or oligomer chain ends, or a thermoplastic branched prepolymer or oligomer with at least two of the prepolymer or oligomer branches and chain ends capped with an epoxy or oxirane group; and
(b) (i) curing the resulting epoxy-capped prepolymer or oligomer with at least one polybasic acid, or (ii) thermally curing the resulting epoxy-capped prepolymer or oligomer, to produce a pressure sensitive adhesive.

4. The method of claim 2, wherein the dibasic acid comprises a dimer acid.

5. The method of claim 4, wherein the dimer acid has an average of two carboxylic acid groups per molecule.

6. The method of claim 4, wherein the dimer acid is a dimer of oleic acid and/or linoleic acid.

7. The method of claim 2, wherein the dibasic acid comprises sebacic acid.

8-12. (canceled)

13. The method of claim 2, wherein the epoxide includes at least two epoxy functional groups.

14. The method of claim 13, wherein the epoxide comprises a diglycidyl-containing compound.

15. The method of claim 14, wherein the diglycidyl-containing compound is selected from an alkyl diglycidyl ether, an alkyl diglycidyl ester, or a bisphenol diglycidyl ether.

16. The method of claim 2, wherein the polyfunctional epoxide includes three or more epoxy functional groups.

17. The method of claim 16, wherein the polyfunctional epoxide comprises an aliphatic triglycidyl or polyglycidyl ether or an aromatic triglycidyl or polyglycidyl ether.

18. The method of claim 16, wherein the polyfunctional epoxide comprises an epoxy functionalized polybutadiene or an epoxidized fatty acid ester.

19. The method of claim 2, wherein the amount of dibasic acid or anhydride thereof reacted with the epoxide having at least two epoxy or oxirane groups, diol or polyol, or diamine is in a molar ratio of carboxylic acid groups present in the dibasic acid to epoxy functional groups, hydroxyl groups, or amine groups present in the epoxide, diol or polyol, or diamine, respectively, ranging from 1.005:1 to 100:1.

20. The method of claim 2, wherein step (a) further comprises heating the dibasic acid/epoxide, diol or polyol, or diamine reaction mixture at a temperature of 20 to 300° C. for 1 to 180 minutes.

21. The method of claim 2, wherein step (b) further comprises heating the carboxylic acid-capped thermoplastic prepolymer or oligomer/polyfunctional epoxide reaction mixture at a temperature of 30 to 300° C. for 1 to 120 minutes.

22. The method of claim 2, further comprising applying the carboxylic acid-capped thermoplastic prepolymer or oligomer/polyfunctional epoxide reaction product onto a backing substrate or a release liner and heating the reaction product on the backing substrate or release liner at a temperature of 100-300° C. for 10 seconds to 100 minutes.

23. The method of claim 3, wherein the polybasic acid includes at least three carboxylic acid functional groups.

24. The method of claim 23, wherein the polybasic acid is selected from 1,2,3,4-butanetetracarboxylic acid, ethylenediamine tetraacetic acid, citric acid, trimer acid, or a polymerized fatty acid.

25. The method of claim 3, wherein the amount of dibasic acid or anhydride thereof reacted with the epoxide having at least two epoxy or oxirane groups is in a molar ratio of epoxy functional groups present in the epoxide to carboxylic acid groups present in the dibasic acid ranging from 1.005:1 to 100:1.

26. The method of claim 3, wherein step (a) further comprises heating the dibasic acid/epoxide reaction mixture at a temperature of 20 to 300° C. for 1 to 180 minutes.

27. The method of claim 3, wherein step (b) further comprises heating the epoxy-capped thermoplastic epoxy prepolymer or oligomer/polybasic acid reaction mixture at a temperature of 30 to 300° C. for 1 to 120 minutes.

28. The method of claim 3, further comprising applying the epoxy-capped thermoplastic epoxy prepolymer or oligomer/polybasic acid reaction product onto a backing substrate or a release liner and heating the reaction product on the backing substrate or release liner at a temperature of 100-300° C. for 10 seconds to 100 minutes.

29. The method of claim 3, wherein the thermal curing in step (b)(ii) is at a temperature of 20 to 300° C.

30. The method of claim 13, wherein the epoxide is selected from bisphenol A diglycidyl ether, bisphenol A ethoxylate diglycidyl ether, bisphenol A propoxylate diglycidyl ether, bisphenol F diglycidyl ether, bisphenol F ethoxylate diglycidyl ether, bisphenol F propoxylate diglycidyl ether, ethylene glycol diglycidyl ether, diethylene glycol diglycidyl ether, poly(ethylene glycol) diglycidyl ether, propylene glycol diglycidyl ether, dipropylene glycol diglycidyl ether, poly(propylene glycol) diglycidyl ether, 1,3-butanediol diglycidyl ether, 1,4-butanediol diglycidyl ether, neopentyl glycol diglycidyl ether, glycerol diglycidyl ether, diglycidyl 1,2,3,6-tetrahydrophthalate, 1,2-cyclohexanedicarboxylate diglycidyl ether, dimer acid diglycidyl ester, 1,4-cyclohexanedimethanol diglycidyl ether, resorcinol diglycidyl ether, poly(dimethylsiloxane) terminated with diglycidyl ether, or epoxidized linoleic acid ester.

31. The method of claim 2, wherein the dibasic acid or anhydride thereof is selected from oxalic acid, malonic acid, itaconic acid, succinic acid, glutaric acid, adipic acid, pimelic acid, suberic acid, azelaic acid, sebacic acid, brassylic acid, docosanedioic acid, phthalic acid, isophthalic acid, terephthalic acid, succinic anhydride, itaconic anhydride, phthalic anhydride, 1,2,3,4-butanetetracarboxylic acid, ethylenediamine tetraacetic acid, citric acid, trimellitic acid, trimellitic anhydride, dimer acid, trimer acids, or a polymerized fatty acid.

32. A pressure sensitive adhesive construct comprising:
(A) a backing substrate; and
(B) a pressure sensitive adhesive disposed on the backing substrate, wherein the pressure sensitive adhesive comprises a pressure sensitive adhesive made by the method of claim 2.

33-38. (canceled)

39. A method for making a pressure sensitive adhesive construct comprising:
reacting (i) at least one dibasic acid or anhydride thereof with (ii) at least one epoxide having at least two epoxy groups, at least one diol or polyol, or at least one diamine at a stoichiometric molar excess of reactive carboxylic acid groups relative to reactive epoxy groups, hydroxyl groups or amine groups to produce a thermoplastic prepolymer or oligomer capped with a carboxylic acid group at both prepolymer or oligomer chain ends, or a thermoplastic branched prepolymer or oligomer with at least two of the prepolymer or oligomer branches and chain ends capped with a carboxylic acid group;
reacting the resulting carboxylic acid-capped prepolymer or oligomer with at least one polyfunctional epoxide, wherein the polyfunctional epoxide is not an epoxidized vegetable oil; and
forming on a backing substrate a pressure sensitive adhesive from the resulting reaction product.

40. The method of claim 39, wherein the forming of the pressure sensitive adhesive on the backing substrate comprises applying the carboxylic acid-capped thermoplastic prepolymer or oligomer/polyfunctional epoxide reaction product to the backing substrate and thermally curing the carboxylic acid-capped thermoplastic prepolymer or oligomer/polyfunctional epoxide reaction product on the substrate to form the pressure sensitive adhesive.

41. The method of claim 39, wherein
the carboxylic acid-capped thermoplastic prepolymer or oligomer/polyfunctional epoxide reaction product is applied onto a release liner or a backing substrate;
a backing substrate is placed onto a surface of the carboxylic acid-capped thermoplastic prepolymer or oligomer/polyfunctional epoxide reaction product coating opposing the release liner, or a release liner is placed on a surface of the carboxylic acid-capped thermoplastic prepolymer or oligomer/polyfunctional epoxide reaction product coating opposing the backing substrate, to form a release liner/reaction product/backing substrate assembly;
pressure is applied to the resulting assembly; and
at least the carboxylic acid-capped thermoplastic prepolymer or oligomer/polyfunctional epoxide reaction product on the backing substrate or release liner is heated to produce the pressure sensitive adhesive composition.

42. (canceled)

43. A method for making a pressure sensitive adhesive construct comprising:
reacting at least one dibasic acid or anhydride thereof with at least one epoxide having at least two epoxy or oxirane groups at a stoichiometric molar excess of reactive epoxy or oxirane groups relative to reactive carboxylic acid groups to produce a thermoplastic prepolymer or oligomer capped with an epoxy or an oxirane group at both prepolymer or oligomer chain ends, or a thermoplastic branched prepolymer or oligomer with at least two of the prepolymer or oligomer branches and chain ends capped with an epoxy or oxirane group; and
reacting the resulting epoxy-capped prepolymer or oligomer with at least one polybasic acid; and
forming on a backing substrate a pressure sensitive adhesive from the resulting reaction product.

44. The method of claim 43, wherein the forming of the pressure sensitive adhesive on the backing substrate comprises applying the epoxy-capped thermoplastic prepolymer or oligomer/polybasic acid reaction product to the backing substrate and thermally curing the epoxy-capped thermoplastic prepolymer or oligomer/polybasic acid reaction product on the substrate to form the pressure sensitive adhesive.

45. The method of claim 43, wherein
the epoxy-capped thermoplastic prepolymer or oligomer/polybasic acid reaction product is applied onto a release liner or a backing substrate;
a backing substrate is placed onto a surface of the epoxy-capped thermoplastic prepolymer or oligomer/polybasic acid reaction product coating opposing the release liner, or a release liner is placed on a surface of the epoxy-capped thermoplastic prepolymer or oligomer/polybasic acid reaction product coating opposing the backing substrate, to form a release liner/reaction product/backing substrate assembly;
pressure is applied to the resulting assembly; and
at least the epoxy-capped thermoplastic prepolymer or oligomer/polybasic acid reaction product on the backing substrate or release liner is heated to produce the pressure sensitive adhesive composition.

46. The method of claim 43, wherein the method comprises:
applying the epoxy-capped thermoplastic prepolymer or oligomer/polybasic acid reaction product onto a first release liner;
placing a second release liner onto a surface of the reaction product coating opposing the first release liner to form a first release liner/reaction product/second release liner assembly;
applying pressure to the resulting assembly;
heating the resulting assembly;
removing the second release liner; and
placing a backing substrate onto a surface of the reaction product coating opposing the first release liner to form a first release liner/pressure sensitive adhesive/backing substrate assembly.

47-48. (canceled)

49. The method of claim 3, wherein the dibasic acid comprises a dimer acid.
